(19) United States
(12) Patent Application Publication
(10) Pub. No.: US 2004/0239580 A1
(43) Pub. Date: Dec. 2, 2004

(54) Illumination device and display apparatus including the same

(75) Inventors: Shinpei Nagatani, Kawasaki (JP); Tetsuya Kobayashi, Kawasaki (JP); Yoshio Koike, Kawasaki (JP); Kazutaka Hanaoka, Kawasaki (JP); Hidefumi Yoshida, Kawasaki (JP); Yuichi Inoue, Kawasaki (JP); Kimiaki Nakamura, Kawasaki (JP); Katsunori Tanaka, Kawasaki (JP); Katsuhiko Kishida, Kawasaki (JP)

Correspondence Address: Patrick G. Burns, Esq., GREER, BURNS & CRAIN, LTD., Suite 2500, 300 South Wacker Drive, Chicago, IL, 60606, US

(73) Assignee: FUJITSU DISPLAY TECHNOLOGIES CORPORATION

(21) Appl. No.: 10/813,613

(22) Filed: Mar. 30, 2004

(30) Foreign Application Priority Data
Mar. 31, 2003 (JP) 2003-094636

(51) Int. Cl. G09G 5/00

(52) U.S. Cl. 345/1.3

(57) ABSTRACT

The invention relates to a display apparatus used as a display part of an information equipment and an illumination device used for the same, and has an object to provide the display apparatus which can obtain excellent display characteristics and the illumination device used for the same. The illumination device includes plural optical waveguides which include diffusion reflecting layers for diffusing and reflecting guided light, light emission surfaces for emitting the diffused and reflected light, and plural light-emitting areas in which the diffusion reflecting layers are formed and which are separated from each other, and which are stacked so that the plural light-emitting areas are disposed almost complementarily when viewed in a direction vertical to the light emission surfaces, and plural light sources respectively disposed at ends of the plural optical waveguides.

### BACKGROUND OF THE INVENTION

1. Field of the Invention

The present invention relates to a display apparatus used as a display part of an information equipment and an illumination device used for the same.

2. Description of the Related Art

A liquid crystal display apparatus has been requested, as its market has been expanded, to have display characteristics comparable to or superior to a CRT (Cathode-Ray Tube) of a conventional typical display apparatus. However, it is widely known that the liquid crystal display apparatus is inferior to the CRT in the display characteristics especially when moving images are displayed. With respect to the display characteristics of the liquid crystal display apparatus, one of problems which are intensely requested to be improved is the tailing (blur) of display. The tailing of display occurs because the response time of a liquid crystal molecule is long and the display system of the liquid crystal display apparatus is of a hold type. In order to make the tailing hard to visually identify, a scan backlight system is proposed in which a backlight unit is divided for a plurality of respective areas, and a light source of each divided area is turned on and off in synchronization with the writing of gradation data. In the liquid crystal display apparatus using the scan backlight system, an impulse type display similar to the CRT becomes possible.

In the scan backlight system, since it is necessary to sequentially turn on and off the light source for each divided area, a direct type backlight unit is used in which plural cold-cathode tubes (fluorescent tubes) are disposed on the back side of a liquid crystal display panel substantially in parallel to a gate bus line.

FIG. 41 shows a sectional structure obtained by cutting a conventional direct type backlight unit, which can support the scan backlight system, along a plane orthogonal to a tube axis direction of a cold-cathode tube. As shown in FIG. 41, a direct type backlight unit 1001 includes a reflection box 1014 opened on the side of a light-emitting surface 1010. Plural cold-cathode tubes 1012 are disposed in parallel to each other just below the light-emitting surface 1010 in the reflection box 1014. An incomplete partition 1015 is provided between the adjacent cold-cathode tubes 1012. A diffusion plate 1016 is disposed on the side of the light-emitting surface 1010 of the reflection box 1014. A diffusion sheet 1018 is disposed further on the light emission direction side of the diffusion plate 1016.

[Patent document 1] JP-A-5-2908

[Patent document 2] JP-A-5-173131

[Patent document 3] JP-A-7-159619

[Patent document 4] JP-A-8-86917

[Patent document 5] JP-A-11-125818

[Patent document 6] JP-A-6-332386

[Patent document 7] JP-A-7-5426

[Patent document 8] JP-A-7-281150

[Patent document 9]JP-A-2001-272652

[Patent document 10] JP-A-10-186310

[Patent document 11] JP-A-11-202286

[Patent document 12] JP-A-2000-147454

[Patent document 13] JP-A-2001-290124

[Patent document 14] JP-A-2001-272657

[Patent document 15] JP-A-9-106262

In the direct type backlight unit 1001, uneven brightness and uneven chromaticity are apt to occur on the light-emitting surface 1010 due to a difference in brightness and a difference in chromaticity between the adjacent cold-cathode tubes 1012 or the arrangement of the cold-cathode tubes 1012 disposed side by side through predetermined gaps.

Besides, in the direct type backlight unit 1001, there are no effective measures against various factors of the uneven brightness, such as initial or time degradation change and fluctuation of brightness and color among the plural cold-cathode tubes 1012, and optical time degradation of members around the light sources. Conventionally, although the uneven brightness is suppressed by increasing the distance between the diffusion plate 1016 as the light-emitting surface 1010 and the cold-cathode tubes 1012, this has not been sufficient as the measure against the uneven brightness. Besides, even if the initial uneven brightness can be suppressed, there are no measures against variable elements such as brightness fluctuation due to the time degradation of the cold-cathode tubes 1012 or brightness fluctuation in manufacture of the respective cold-cathode tubes 1012, and there is a problem that the occurrence of the uneven brightness can not be avoided.

### SUMMARY OF THE INVENTION

An object of the present invention is to provide a display apparatus which can obtain excellent display characteristics and an illumination device used for the same.

The above object is achieved by an illumination device including plural optical waveguides each of which includes a light diffusion reflecting surface for diffusing and reflecting guided light, a light emission surface for emitting the diffused and reflected light, and plural light-emitting areas in which the light diffusion reflecting surface is formed and which are separated from each other, the optical waveguides being stacked so that the plural light-emitting areas are disposed almost complementarily when viewed in a direction vertical to the light emission surface, and plural light sources respectively disposed at ends of the plural optical waveguides.

### BRIEF DESCRIPTION OF THE DRAWINGS

FIG. 1 is a sectional view showing a structure obtained by cutting a display apparatus according to a first embodiment of the invention along a plane orthogonal to a tube axis direction of a cold-cathode tube;

FIG. 2 is a sectional view showing a structure obtained by cutting an illumination device according to the first embodiment of the invention along a plane orthogonal to the tube axis direction of the cold-cathode tube;

FIG. 3 is a sectional view showing a schematic structure of an MVA mode liquid crystal display apparatus;

FIG. 4 is a sectional view showing a schematic structure of an IPS mode liquid crystal display apparatus;

FIG. 5 is a graph showing temporal changes of display brightness in one pixel of a liquid crystal display apparatus and a CRT;

FIG. 6 is a sectional view showing a structure of a liquid crystal display apparatus as the premise of a second embodiment of the invention;

FIG. 7 is a sectional view schematically showing a structure of an illumination device as the premise of the second embodiment of the invention;

FIG. 8 is a sectional view schematically showing a structure of an illumination device according to example 2-1 of the second embodiment;

FIG. 9 is a sectional view schematically showing a structure of an illumination device according to example 2-2 of the second embodiment;

FIG. 10 is a sectional view schematically showing a structure of an illumination device according to example 2-3 of the second embodiment;

FIG. 11 is a sectional view schematically showing a structure of an illumination device according to example 2-4 of the second embodiment;

FIG. 12 is a sectional view schematically showing a structure of an illumination device according to example 2-5 of the second embodiment;

FIG. 13 is a sectional view schematically showing a modified example of the structure of the illumination device according to the example 2-5 of the second embodiment;

FIG. 14 is a sectional view schematically showing a structure of an illumination device according to example 2-6 of the second embodiment;

FIG. 15 is a view showing a structure of an illumination device according to example 2-6 of the second embodiment of the invention when viewed from a display screen side;

FIG. 16 is a view showing a modified example of the structure of the illumination device according to the example 2-6 of the second embodiment of the invention when viewed from the display screen side;

FIG. 17 is an enlarged view showing an area a of an illumination device shown in FIG. 6;

FIG. 18 is a partial sectional view showing a structure of an illumination device according to example 3-1 of a third embodiment of the invention;

FIG. 19 is a partial sectional view showing a modified example of the structure of the illumination device according to the example 3-1 of the third embodiment of the invention;

FIG. 20 is a sectional view showing a structure of an illumination device according to example 3-2 of the third embodiment of the invention and a display apparatus including the same;

FIG. 21 is a sectional view showing a schematic structure of an illumination device according to example 3-3 of the third embodiment of the invention and a display apparatus including the same;

FIG. 22 is a sectional view schematically showing a liquid crystal layer of a liquid crystal display panel of the illumination device according to the example 3-3 of the third embodiment of the invention;

FIG. 23 is a sectional view showing a plane structure of one transparent substrate of the liquid crystal display panel of the illumination device according to the example 3-3 of the third embodiment of the invention;

FIG. 24 is a sectional view showing a structure of an illumination device as the premise of a fourth embodiment of the invention;

FIG. 25 is a sectional view showing a structure of an illumination device according to example 4-1 of the fourth embodiment;

FIG. 26 is a sectional view showing a structure of the vicinity of a light source changeover part of the illumination device according to the example 4-1 of the fourth embodiment;

FIG. 27 is a partial sectional view showing a structure of a partial optical waveguide in an illumination device according to example 4-2 of the fourth embodiment;

FIG. 28 is a sectional view showing a structure of an illumination device according to example 4-3 of the fourth embodiment;

FIG. 29 is a sectional view showing a structure of an illumination device according to example 5-1 of a fifth embodiment of the invention and a display apparatus including the same;

FIGS. 30A and 30B are perspective views showing structures of a light source part and a cylindrical member of the illumination device according to the example 5-1 of the fifth embodiment of the invention;

FIGS. 31A and 31B are views showing states of the illumination device according to the example 5-1 of the fifth embodiment of the invention at certain times;

FIG. 32 is a sectional view showing a structure of an illumination device according to example 5-2 of the fifth embodiment;

FIG. 33 is a view showing an equivalent circuit of each pixel of a display apparatus according to a sixth embodiment of the invention;

FIG. 34 is a timing chart showing a driving method of an illumination device according to the sixth embodiment of the invention and a display apparatus including the same;

FIG. 35 is a functional block diagram showing a structure of a general liquid crystal display apparatus as the premise of a seventh embodiment of the invention;

FIG. 36 is a view showing a display screen of the general liquid crystal display apparatus as the premise of the seventh embodiment of the invention;

FIG. 37 is a view showing a brightness profile of the display screen of the general liquid crystal display apparatus as the premise of the seventh embodiment of the invention;

FIG. 38 is a functional block diagram showing a structure of a liquid crystal display apparatus according to the seventh embodiment of the invention;

FIG. 39 is a view showing a display screen of the liquid crystal display apparatus according to the seventh embodiment of the invention;

FIG. 40 is a view showing a brightness profile of the display screen of the liquid crystal display apparatus according to the seventh embodiment of the invention; and

FIG. 41 is a view showing a sectional structure obtained by cutting a conventional direct type backlight unit, which can support a scan backlight system, along a plane orthogonal to a tube axis direction of a cold-cathode tube.

### DETAILED DESCRIPTION OF THE INVENTION

[First Embodiment]

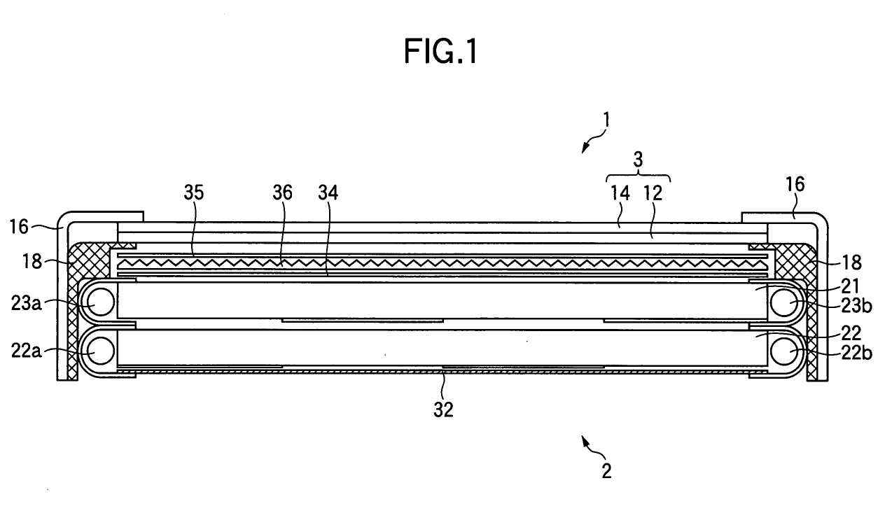

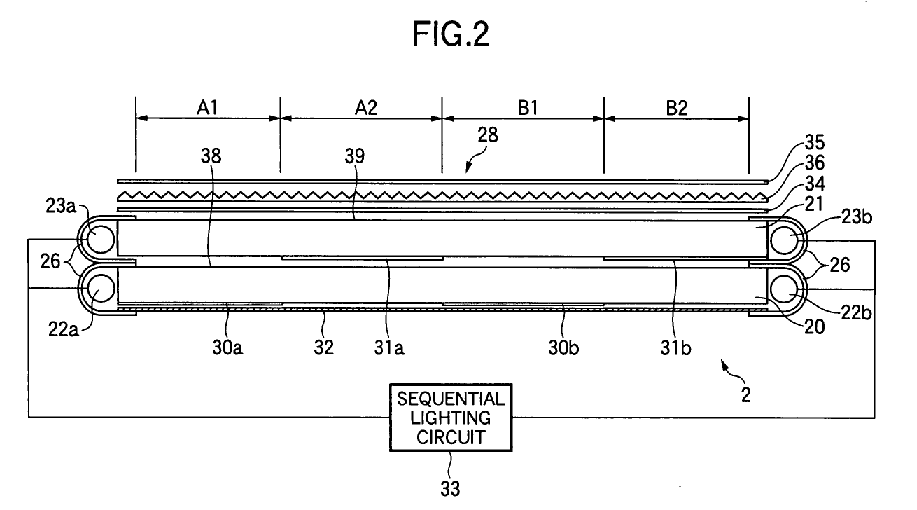

An illumination device according to a first embodiment of the invention and a display apparatus including the same will be described with reference to FIGS. 1 and 2. FIG. 1 shows a sectional structure obtained by cutting an active matrix type liquid crystal display apparatus, as an example of a display apparatus according to this embodiment, along a plane orthogonal to a tube axis direction of a cold-cathode tube. As shown in FIG. 1, a liquid crystal display apparatus 1 includes a backlight unit 2 and a liquid crystal display panel 3 mounted on the backlight unit 2. Besides, the liquid crystal display apparatus 1 includes a metal bezel 16 opened so that a display area of the liquid crystal display panel 3 is exposed, and a resin frame 18 opened similarly to the metal bezel 16. The liquid crystal display panel 3 and the backlight unit 2 are fixed by the metal bezel 16 and the resin frame 18, and the liquid crystal display apparatus 1 is put in a unit state by this.

The liquid crystal display panel 3 includes a TFT substrate 12 in which a TFT is formed as a switching element for each pixel, an opposite substrate 14 which is disposed to be opposite to the TFT substrate 12 and in which a color filer (CF) and the like are formed and a liquid crystal (not shown) sealed between both the substrates 12 and 14.

FIG. 2 shows a sectional structure of the backlight unit 2. As shown in FIG. 2, the backlight unit 2 includes two substantially plate-shaped transparent optical waveguides 20 and 21. The optical waveguide 20 includes a light emission surface 38 for emitting light at a surface side (display screen side). The optical waveguide 21 includes a light emission surface 39 for emitting light at a surface side (display screen side). The optical waveguides 20 and 21 are overlapped and disposed so that the light emission surface 38 of the optical waveguide 20 is opposite to the back surface of the optical waveguide 21. In FIG. 2, a cold-cathode tube 22a as a light source is disposed in the vicinity of a left end face of the optical waveguide 20, and a cold-cathode tube 22b is disposed in the vicinity of a right end face. Besides, a cold-cathode tube 23a is disposed in the vicinity of a left end face of the optical waveguide 21, and a cold-cathode tube 23b is disposed in the vicinity of a right end face. A reflector 26 having a U-shaped section is disposed around each of the cold-cathode tubes 22a, 22b, 23a and 23b in order to make light efficiently incident on each of the optical waveguides 20 and 21.

A light-emitting surface 28 of the backlight unit 2 has four light-emitting areas A1, A2, B1 and B2 divided along gate bus lines formed in the liquid crystal display panel 3. The light-emitting areas A1, A2, B1 and B2 have, for example, almost the same area when viewed from the display screen side.

A diffusion reflecting layer (diffusion reflecting surface) 30a as a light-extracting element for extracting light guided from the cold-cathode tube 22a to the outside is formed in the light-emitting area A1 of the optical waveguide 20. The diffusion reflecting layer 30a is adjusted so that when the cold-cathode tube 22a closer to the light-emitting area A1 in the two cold-cathode tubes 22a and 22b is turned on, the light-emitting area A1 emits light at the highest brightness. A diffusion reflecting layer 30b for extracting light guided from the cold-cathode tube 22b to the outside is formed in the light-emitting area B1 of the optical waveguide 20. The diffusion reflecting layer 30b is adjusted so that when the cold-cathode tube 22b closer to the light-emitting area B1 in the two cold-cathode tubes 22a and 22b is turned on, the light-emitting area B1 emits light at the highest brightness. A diffusion reflecting layer is not formed in the light-emitting areas A2 and B2 of the optical waveguide 20.

A diffusion reflecting layer 31a for extracting light guided from the cold-cathode tube 23a to the outside is formed in the light emission area A2 of the optical waveguide 21. The diffusion reflecting layer 31a is adjusted so that when the cold-cathode tube 23a closer to the light-emitting area A2 in the two cold-cathode tubes 23a and 23b is turned on, the light-emitting area A2 emits light at the highest brightness. A diffusion reflecting layer 31b for extracting light guided from the cold-cathode tube 23b to the outside is formed in the light-emitting area B2 of the optical waveguide 21. The diffusion reflecting layer 31b is adjusted so that when the cold-cathode tube 23b closer to the light-emitting area B2 in the two cold-cathode tubes 23a and 23b is turned on, the light-emitting area B2 emits light at the highest brightness. A diffusion reflecting layer is not formed in the light-emitting areas A1 and B1 of the optical waveguide 21. Thus, the lights emitted from the light-emitting areas A1 and B1 of the optical waveguide 20 are transmitted toward the side of the light-emitting surface 28 at high efficiency.

In the structure of this embodiment, the respective diffusion reflecting layers 30a, 30b, 31a and 31b are disposed so that they do not overlap with each other when viewed in the direction vertical to the display screen. However, the respective diffusion reflecting layers 30a, 30b, 31a and 31b may be disposed so that they partially overlap with each other when viewed in the direction vertical to the display screen.

A diffusion reflecting sheet 32 for diffusing and reflecting light emitted from the optical waveguide 20 to the back side of the optical waveguide 20 is disposed on the back side of the optical waveguide 20. A diffusion sheet 34, a prism sheet 36 and a diffusion sheet 35 for diffusing light emitted from the optical waveguide 21 to the surface side of the optical waveguide 21 are stacked in this order and are disposed on the surface side of the optical waveguide 21.

In the structure as stated above, when only the cold-cathode tube 22a is turned on, the light-emitting area A1 emits light at higher brightness than the other light-emitting areas A2, B1 and B2. Similarly, when only the cold-cathode tube 23a is turned on, the light-emitting area A2 emits light at higher brightness than the other light-emitting areas A1, B1 and B2. When only the cold-cathode tube 22b is turned on, the light-emitting area B1 emits light at higher brightness than the other light-emitting areas A1, A2 and B2. When only the cold-cathode tube 23b is turned on, the light-emitting area B2 emits light at higher brightness than the other light-emitting areas A1, A2 and B1.

The respective cold-cathode tubes 22a, 22b, 23a and 23b are sequentially intermittently turned on by a sequential lighting circuit 33 of a light source control system. The sequential lighting circuit 33 receives a latch pulse from a not-shown control circuit, and synchronizes with one of gate pulses of the line-sequentially driven liquid crystal display panel 3 and intermittently turns on the respective cold-cathode tubes 22a, 22b, 23a and 23b. When the cold-cathode tubes 22a, 22b, 23a and 23b are turned on and off at a relatively high flashing frequency, although only one of the light-emitting areas A1, A2, B1 and B2 is instantaneously partially turned on, the whole display screen is seen by an observer as if it uniformly emits light.

According to this embodiment, the side-light type backlight unit which can support the scan backlight system can be realized. Since the side-light type backlight unit can make the whole light-emitting area almost uniform, uneven brightness is not easily visually identified on the display screen, and even if there occurs time degradation of the cold-cathode tubes or brightness fluctuation in manufacture, the display characteristics are not easily lowered. Besides, since the backlight unit can support the scan backlight system, the display characteristics especially at the time when moving images are displayed are improved by performing the impulse type display.

[Second Embodiment]

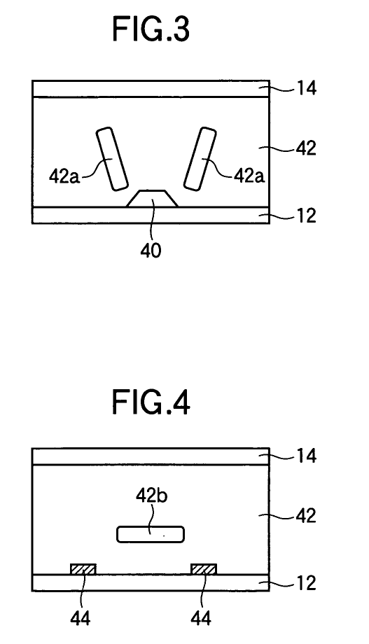

Next, an illumination device according to a second embodiment of the invention and a display apparatus including the same will be described with reference to FIGS. 3 to 16. This embodiment relates to an illumination device which can obtain high display quality and a display apparatus including the same. Especially, this embodiment relates to a scan type illumination device for clearly displaying moving images and a display apparatus including the same.

As a liquid crystal display apparatus having high quality and being excellent in viewing angle characteristics, an MVA (Multi-domain Vertical Alignment) mode and an IPS (In-Plane Switching) mode are well known.

FIG. 3 shows a schematic sectional structure of an MVA mode liquid crystal display apparatus. As shown in FIG. 3, the MVA mode liquid crystal display apparatus includes a TFT substrate 12, an opposite substrate 14, and a liquid crystal 42 sealed between both the substrates 12 and 14. The liquid crystal 42 has negative dielectric anisotropy. For example, a linear projection 40 as an alignment controlling structure for controlling the alignment of the liquid crystal 42 is formed on the TFT substrate 12. Although not shown, a vertical alignment film is formed on the opposite surfaces of both the substrates 12 and 14. In the state where a voltage is not applied to the liquid crystal 42, liquid crystal molecules 42a in the vicinity of the linear projection 40 are inclined from the direction vertical to the substrate surface to the directions of the normals of inclined surfaces of the linear projection 40. By applying a predetermined voltage to the liquid crystal 42, the liquid crystal molecules 42a come to fall down in different directions with the linear projection 40 as a boundary. In the MVA mode liquid crystal display apparatus, since the direction in which the liquid crystal molecules 42a are inclined is divided in, for example, four directions in one pixel, excellent viewing angle characteristics can be obtained.

FIG. 4 shows a schematic sectional structure of an IPS mode liquid crystal display apparatus. As shown in FIG. 4, in the IPS mode liquid crystal display apparatus, a predetermined voltage is applied between pixel electrodes 44 formed into a comb-tooth shape on a TFT substrate 12, and a liquid crystal molecule 42b is switched by a lateral electric field in the horizontal direction with respect to the substrate. In the IPS mode liquid crystal display apparatus, since the liquid crystal molecule 42b is always almost horizontal with respect to the substrate, excellent viewing angle characteristics can be obtained.

However, these liquid crystal display apparatuses also have disadvantages. Especially in the case where moving images are displayed, it is widely known that the display characteristics of the liquid crystal display apparatus performing the hold type display are generally remarkably inferior to the CRT or the like for performing the flashing (impulse) type display.

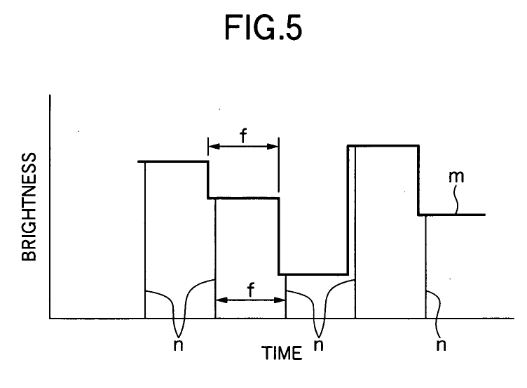

FIG. 5 is a graph showing temporal changes of display brightness in one pixel of the liquid crystal display apparatus and the CRT performing the same moving image display. The horizontal axis indicates time, and the vertical axis indicates brightness. A line m indicates the temporal change of the display brightness of the liquid crystal display apparatus, and a line n indicates the temporal change of the display brightness of the CRT. As shown in FIG. 5, the pixel of the CRT instantaneously emits light at predetermined brightness every frame period f (for example, 16 msec), while the pixel of the liquid crystal display apparatus is kept at almost the same brightness in the frame period f. In the hold type display like the liquid crystal display apparatus, a blur occurs at the time of the display of moving images.

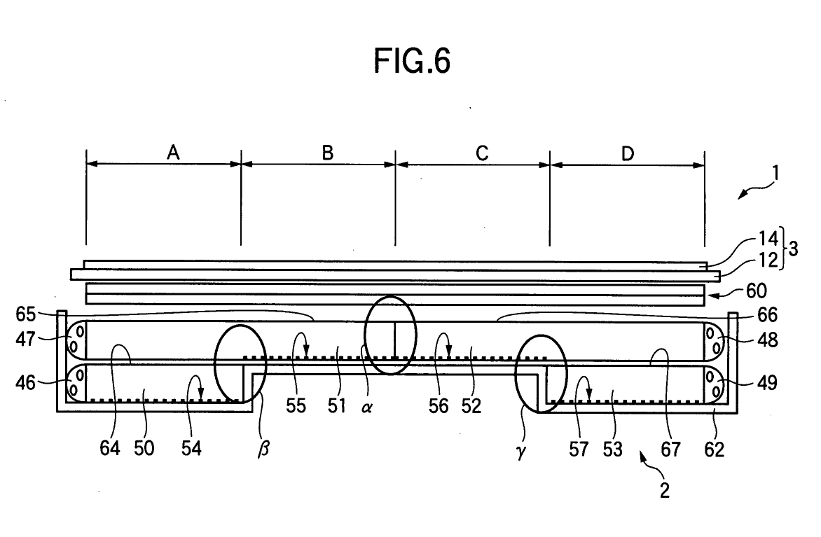

Then, some structures of the liquid crystal display apparatus to solve the above problem have been proposed. As one of them, there is a structure in which a scan type backlight unit and a liquid crystal display panel are combined. FIG. 6 shows a structure of a liquid crystal display apparatus as the premise of this embodiment. As shown in FIG. 6, a liquid crystal display apparatus 1 includes a scan type backlight unit 2 and a liquid crystal display panel 3. The backlight unit 2 includes light-emitting areas A to D for providing illumination, which are obtained by dividing a display area of the line-sequentially driven liquid crystal display panel 3 into four parts in a scan direction. The light-emitting areas A to D have, for example, almost the same emission superficial content. Light from the light-emitting area A of the backlight unit 2 illuminates an area A to be illuminated of the liquid crystal display panel 3. Similarly, lights from the light-emitting areas B to D of the backlight unit 2 illuminate areas B to D to be illuminated of the liquid crystal display panel. On the display screen, the areas A to D to be illuminated are disposed in this order from the upper part of the screen. Each of the light-emitting areas A to D has a structure that an opening for light emission is formed on the side of the liquid crystal display panel 3, and the other part is surrounded by a diffusion reflecting plate 62. A diffusion sheet 60 is disposed between the opening for light emission of the backlight unit 2 and the liquid crystal display panel 3.

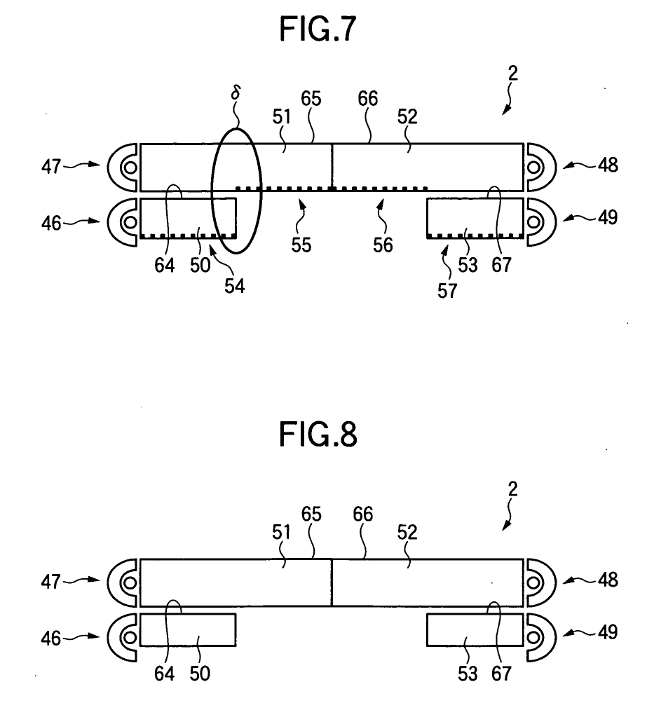

FIG. 7 schematically shows a sectional structure of the backlight unit of the liquid crystal display apparatus shown in FIG. 6. As shown in FIGS. 6 and 7, two optical waveguides (upper optical waveguides) 51 and 52 are disposed on almost the same plane at the back side (lower side of the drawing) of the liquid crystal display panel 3. The optical waveguide 51 is disposed in the light-emitting areas A and B, and the optical waveguide 52 is disposed in the light-emitting areas C and D. A cold-cathode tube 47 is disposed at an end of the optical waveguide 51 opposite to an end facing the optical waveguide 52, and a cold-cathode tube 48 is disposed at an end of the optical waveguide 52 opposite to an end facing the optical waveguide 51.

Besides, in the light-emitting area A, an optical waveguide (lower optical waveguide) 50 is disposed to be adjacent to the back side of the optical waveguide 51. A cold-cathode tube 46 is disposed at one end of the optical waveguide 50. In the light-emitting area D, an optical waveguide (lower optical waveguide) 53 is disposed to be adjacent to the back side of the optical waveguide 52. A cold-cathode tube 49 is disposed at one end of the optical waveguide 53. The cold-cathode tubes 46 to 49 are formed into, for example, linear rod shapes. The length (in the horizontal direction of the drawing) of each of the optical waveguides 50 and 53 is almost half of the length of each of the optical waveguides 51 and 52.

A light-extracting element 54 such as a print scattering layer or a microprism layer is formed in the light-emitting area A (that is, almost the whole area) of the back surface of the optical waveguide 50. A light-extracting element 55 is formed in the light-emitting area B of the back surface of the optical waveguide 51, and the light-extracting element 55 is not formed in the light-emitting area A. A light-extracting element 56 is formed in the light-emitting area C of the back surface of the optical waveguide 52, and the light-extracting element 56 is not formed in the light-emitting area D. A light-extracting element 57 is formed in the light-emitting area D (that is, almost the whole area) of the back surface of the optical waveguide 53.

The backlight unit 2 has such a structure that a light source unit (50, 46) including the optical waveguide 50 and the cold-cathode tube 46 disposed at its end and for causing the light-emitting area A to emit light, and a light source unit (51, 47) including the optical waveguide 51 and the cold-cathode tube 47 disposed at its end and for causing the light-emitting area B to emit light are stacked with each other. Besides, the backlight unit 2 has such a structure that a light source unit (52, 48) including the optical waveguide 52 and the cold-cathode tube 48 disposed at its end and for causing the light-emitting area C to emit light, and a light source unit (53, 49) including the optical waveguide 53 and the cold-cathode tube 49 disposed at its end and for causing the light-emitting area D to emit light are stacked with each other. Further, the backlight unit 2 has such a structure that the light source unit (51, 47) and the light source unit (52, 48) are disposed to be adjacent to each other on almost the same plane. Besides, the backlight unit 2 has such a structure that the light source unit (50, 46) and the light source unit (53, 49) are disposed on almost the same plane.

Specifically, light emitted from the cold-cathode tube 46 is guided in the optical waveguide 50, is extracted by the light-extracting element 54 of the light-emitting area A, and is emitted from a light emission surface 64 of the surface of the optical waveguide 50. The light emitted from the light emission surface 64 passes through the light-emitting area A of the optical waveguide 51 and illuminates the area A to be illuminated of the liquid crystal display panel 3. Light emitted from the cold-cathode tube 47 is guided in the optical waveguide 51, is extracted by the light-extracting element 55 of the light-emitting area B, and is emitted from a light emission surface 65 of the surface of the optical waveguide 51. The light emitted from the light emission surface 65 illuminates the area B to be illuminated of the liquid crystal display panel 3. Light emitted from the cold-cathode tube 48 is guided in the optical waveguide 52, is extracted by the light-extracting element 56 of the light-emitting area C, and is emitted from a light emission surface 66 of the surface of the optical waveguide 52. The light emitted from the light emission surface 66 illuminates the area C to be illuminated of the liquid crystal display panel 3. Light emitted from the cold-cathode tube 49 is guided in the optical waveguide 53, is extracted by the light-extracting element 57 of the light-emitting area D, and is emitted from a light emission surface 67 of the surface of the optical waveguide 53. The light emitted from the light emission surface 67 passes through the light-emitting area D of the optical waveguide 52 and illuminates the area D to be illuminated of the liquid crystal display panel 3. Accordingly, the light-emitting areas A, B, C and D are sequentially made to flash in this order by sequentially turning on and off the cold-cathode tubes 46, 47, 48 and 49.

Although not shown, a reflecting mirror for reflecting light from both sides is disposed in an area a where the optical waveguides 51 and 52 are adjacent to each other. By this, the light-emitting areas B and C are optically separated from each other, and the use efficiency of light is improved. A reflecting mirror for reflecting light from the side of the optical waveguide 50 is disposed at an end face (area β) of the optical waveguide 50 opposite to the cold-cathode tube 46, and a reflecting mirror for reflecting light from the side of the optical waveguide 53 is disposed at an end face (area γ) of the optical waveguide 53 opposite to the cold-cathode tube 49. By this, the use efficiency of light is improved.

In the above described structure of the liquid crystal display apparatus 1 and the backlight unit 2, it is necessary to make the brightnesses of the light-emitting areas A to D uniform with one another. Especially, there is a problem in the uniformity of the brightness between the light-emitting area B where light is emitted from the upper optical waveguide 51 and the light-emitting area A where light is emitted from the lower optical waveguide 50, and between the light-emitting area C where light is emitted from the upper optical waveguide 52 and the light-emitting area D where light is emitted from the lower optical waveguide 53, as well as the brightnesses of the boundary portions. It can be considered that some measure against this is required.

This embodiment has an object to raise display quality, especially the uniformity of brightness as a display apparatus while the structure of the liquid crystal display apparatus 1 and the backlight unit 2 shown in FIGS. 6 and 7 are made the premise.

According to this embodiment, in the structure shown in FIGS. 6 and 7, shapes such as, for example, the thicknesses of the upper optical waveguide 51 and the lower optical waveguide 50, or the thicknesses of the upper optical waveguide 52 and the lower optical waveguide 53, are changed to each other, so that the brightness is made uniform between the light-emitting areas A and B and between the light-emitting areas C and D. Besides, as another measure, there is also a method in which the specifications themselves of the optical waveguide are changed between the upper optical waveguide 51 and the lower optical waveguide 50 and between the upper optical waveguide 52 and the lower optical waveguide 53. For example, one optical waveguide is made to have a wedge shape, and the other optical waveguide is made to have a parallel plate shape. Besides, it is also possible to adjust a scattering reflection function itself by changing the design of a print scattering pattern or a prism pattern formed as the light-extracting element in order to give the scattering reflection function. Further, it is also possible to uniform the brightness by changing the voltage, tube type or the number of the cold-cathode tubes 46 to 49 to adjust the output itself from the cold-cathode tubes 46 to 49. As stated above, there are various methods for ensuring the uniform brightness between the light-emitting areas.

However, even if the light-emitting areas are made uniform by the above method, the brightness of a thin line area at the boundary portion of the light-emitting areas can not be necessarily made uniform. Against this, it is necessary to improve a print scattering pattern layer or a prism pattern layer. For example, a method is conceivable in which the above pattern is formed into a nested shape or mosaic shape at the boundary portion between the light-emitting areas A and B and the boundary portion between the light-emitting areas C and D, and the boundary portion is made blurred. According to this embodiment, it is possible to realize a liquid crystal display apparatus and an illumination device in which even in a large screen, the whole display area has uniform brightness, and moving image characteristics are greatly improved. Hereinafter, the illumination device according to this embodiment will be described by use of specific examples.

### EXAMPLE 2-1

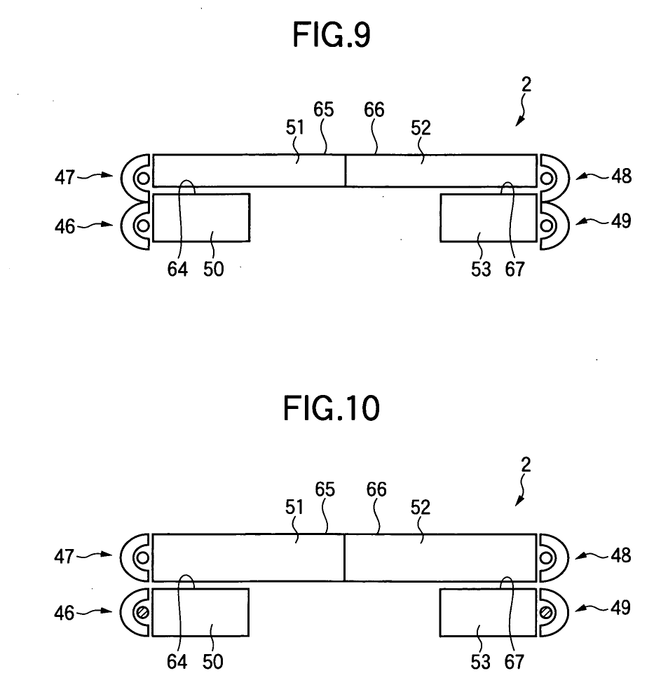

First, an illumination device according to example 2-1 of this embodiment will be described with reference to FIG. 8. FIG. 8 schematically shows a sectional structure of the illumination device according to this example. Incidentally, in FIG. 8 and in FIGS. 9 to 11 described later, graphical representation of the light-extracting element 54 formed in the light-emitting area A of the optical waveguide 50, the light-extracting element 55 formed in the light-emitting area B of the optical waveguide 51, the light-extracting element 56 formed in the light-emitting area C of the optical waveguide 52 and the light-extracting element 57 formed in the light-emitting area D of the optical waveguide 53 is omitted.

As shown in FIG. 8, lower optical waveguides 50 and 53 of a backlight unit 2 are thinner than upper optical waveguides 51 and 52. In general, it is conceivable that as the thickness of an optical waveguide becomes thick, the incident efficiency from a light source to the optical waveguide and the light guiding efficiency in the optical waveguide become high. Thus, in the case where light attenuation in the length direction of the upper optical waveguides 51 and 52 is large, it is effective in ensuring uniform brightness to thin the lower optical waveguides 50 and 53 in which the distance between the cold-cathode tube 46, 49 and the light-extracting element 54, 57 is relatively short.

### EXAMPLE 2-2

Next, an illumination device according to example 2-2 of this embodiment will be described with reference to FIG. 9. FIG. 9 schematically shows a sectional structure of the optical waveguide according to this example. As shown in FIG. 9, lower optical waveguides 50 and 53 of a backlight unit 2 are thicker than upper optical waveguides 51 and 52. In the case where light attenuation in the length direction of the upper optical waveguides 51 and 52 is relatively small, rather, light loss due to the layered structure of the optical waveguides 50 and 51 and the optical waveguides 53 and 52 is large, it is effective in ensuring uniform brightness to increase the thicknesses of the lower optical waveguides 50 and 53 to improve the incident efficiency and the light guiding efficiency, and to increase the amount of light from the lower optical waveguides 50 and 53.

### EXAMPLE 2-3

Next, an illumination device according to example 2-3 of this embodiment will be described with reference to FIG. 10. FIG. 10 schematically shows a sectional structure of the illumination device according to this example. As shown in FIG. 10, lower cold-cathode tubes 46 and 49 of a backlight unit 2 emit light at a brightness different from upper cold-cathode tubes 47 and 48. For example, the cold-cathode tubes 46 and 49 are driven at a tube voltage (tube current), tube frequency or the like different from the cold-cathode tubes 47 and 48. Besides, the number of the cold-cathode tubes 46 and 49 may be made different from that of the cold-cathode tubes 47 and 48. However, for example, when the tube current is increased, the life of the cold-cathode tube generally becomes short. Thus, in this example, it is desirable to select the tube type and the like of the cold-cathode tube in view of the life of the liquid crystal display apparatus.

### EXAMPLE 2-4

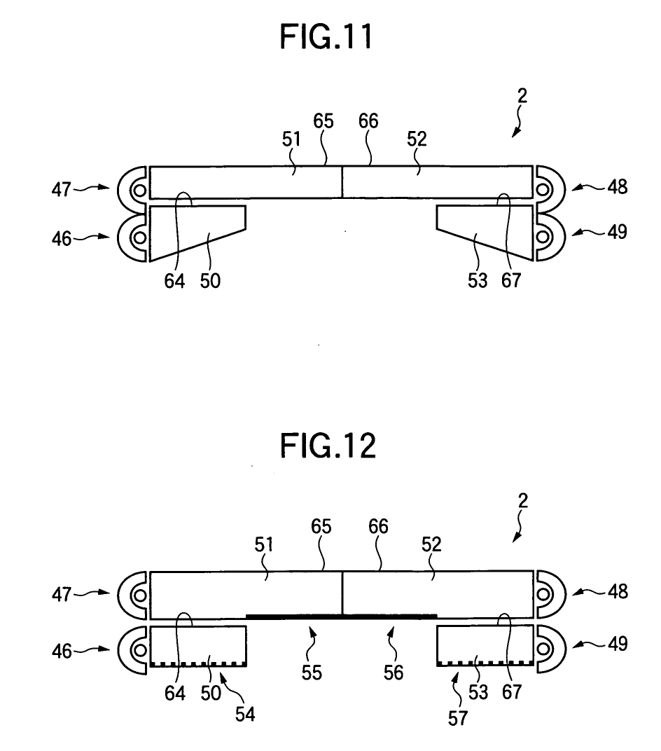

Next, an illumination device according to example 2-4 of this embodiment will be described with reference to FIG. 11. FIG. 11 schematically shows a sectional structure of the illumination device according to this example. As shown in FIG. 11, the shape of upper optical waveguides 51 and 52 of a backlight unit 2 and the shape of lower optical waveguides 50 and 53 are different from each other. Both the upper optical waveguides 51 and 52 are formed into a parallel plate shape. Both the lower optical waveguides 50 and 53 are formed into such a wedge shape that its thickness at the side of the cold-cathode tube 46, 49 is thick. In this embodiment, the brightnesses of respective light-emitting areas A to D are adjusted by combining the optical waveguides 50 and 51 having the shapes different from each other and the optical waveguides 52 and 53, and the brightness is made uniform between the light-emitting areas A and B, and between the light-emitting areas C and D.

### EXAMPLE 2-5

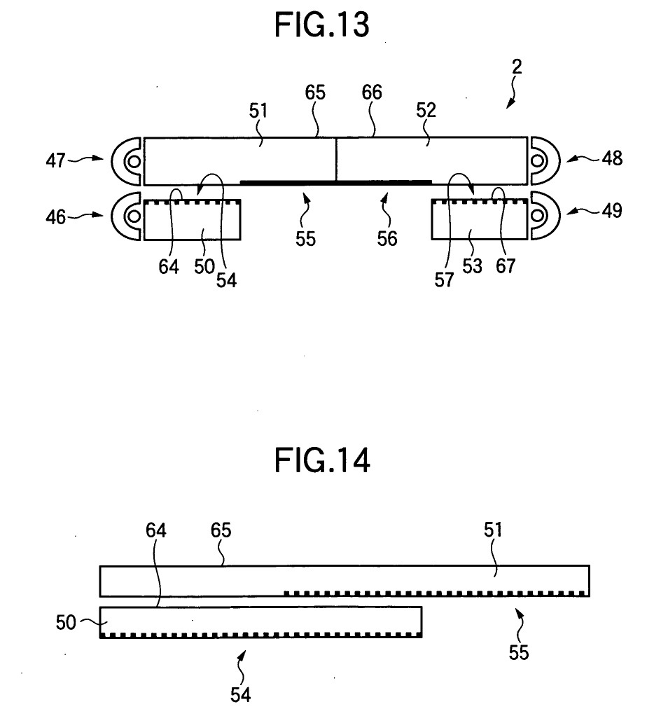

Next, an illumination device according to example 2-5 of this embodiment will be described with reference to FIGS. 12 and 13. FIG. 12 schematically shows a sectional structure of the illumination device according to this example. As shown in FIG. 12, a light-extracting element 54 formed in a light-emitting area A of a lower optical waveguide 50 and a light-extracting element 57 formed in a light-emitting area D of a lower optical waveguide 53 are different in kind from a light-extracting element 55 formed in a light-emitting area B of an upper optical waveguide 51 and a light-extracting element 56 formed in a light-emitting area C of an upper optical waveguide 52. For example, the light-extracting elements 54 and 57 are prism patterns, and the light-extracting elements 55 and 56 are scattering print patterns. In this example, by combining the optical waveguides 50 and 51 in which the different kinds of light-extracting elements 54 and 55 are formed, and the optical waveguides 52 and 53 in which the different kinds of light-extracting elements 56 and 57 are formed, the brightnesses of the light-emitting areas A to D are adjusted, and the brightness is made uniform between the light-emitting areas A and B and between the light-emitting areas C and D.

FIG. 13 shows a modified example of the sectional structure of the illumination device according to this example. As shown in FIG. 13, a light-extracting element 54 is formed on the side of a light emission surface 64 of a lower optical waveguide 50, and a light-extracting element 57 is formed on the side of a light emission surface 67 of a lower optical waveguide 53. In this modified example, by combining the optical waveguides 50 and 51 in which the light-extracting elements 54 and 55 whose kinds and formation positions are different from each other are formed, and the optical waveguides 52 and 53 in which the light-extracting elements 56 and 57 whose kinds and formation positions are different from each other are formed, the brightnesses of the light-emitting areas A to D are adjusted, and the brightness is made uniform between the light-emitting areas A and B and between the light-emitting areas C and D.

Incidentally, in the above examples 2-1 to 2-5, although it is premised that the brightness is made uniform between the light-emitting areas A and B and between the light-emitting areas C and D, it is also naturally possible to make the brightnesses of all the light-emitting areas A to D uniform.

### EXAMPLE 2-6

Next, an illumination device according to example 2-6 of this embodiment will be described with reference to FIGS. 14 to 16. According to the examples 2-1 to 2-5, the brightness can be made almost uniform between the light-emitting areas A and B and between the light-emitting areas C and D. However, uneven brightness at a boundary portion (area δ of FIG. 7) between the light-emitting areas A and B and at a boundary portion between the light-emitting areas C and D are not necessarily dissolved. A brightness change in a short distance is apt to be visually identified even if a variation is small, and the boundary portion where areas slightly different in brightness are adjacent to each other is visually identified as a local lateral streak-like uneven brightness. A backlight unit 2 according to this example has such a structure as to blur the lateral streak-like uneven brightness.

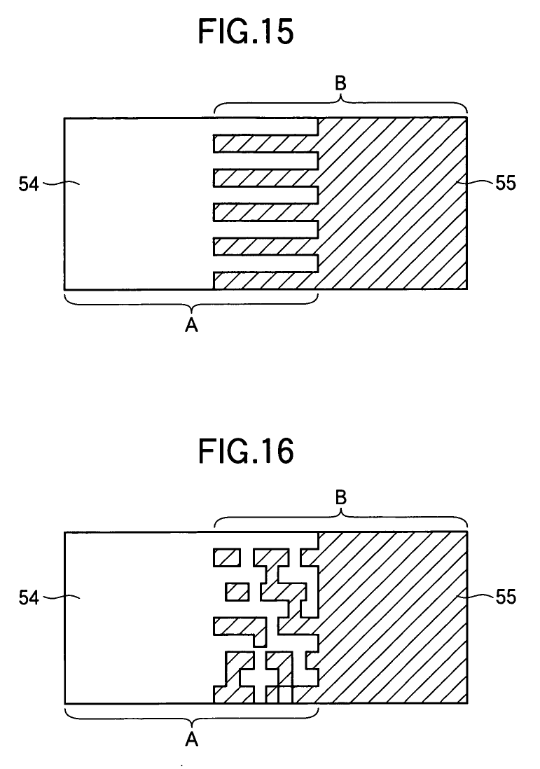

FIG. 14 is an enlarged view of the vicinity of an area corresponding to the area δ of the backlight unit 2 according to this example. FIG. 15 shows a structure of the area shown in FIG. 14 when viewed in the direction vertical to a display screen from the side of a light emission surface 65 of an optical waveguide 51 (that is, the side of the display screen). As shown in FIGS. 14 and 15, a light-extracting element 54 of an optical waveguide 50 is formed to extend like comb teeth toward the side of the light-emitting area B in the vicinity of the boundary portion between the light-emitting areas A and B. On the other hand, a light-extracting element 55 (indicated by hatching in FIG. 15) of an optical waveguide 51 is formed into a complementary comb-tooth shape with respect to the light-extracting element 54 in the vicinity of the boundary portion between the light-emitting areas A and B when viewed from the side of the display screen. As stated above, in the vicinity of the boundary portion between the light-emitting areas A and B, a nested structure in which the light-extracting elements 54 and 55 are mixed with each other is formed when viewed in the direction vertical to the display screen. Thus, even if there is a minute brightness different between the light-emitting areas A and B, a joint becomes unnoticeable on the display screen.

FIG. 16 shows a modified example of the backlight unit 2 shown in FIG. 13. As shown in FIG. 16, a light-extracting element 54 of an optical waveguide 50 of this modified example is formed to be opened at random in the vicinity of a boundary portion between the light-emitting areas A and B. On the other hand, a light-extracting element 55 (indicated by hatching in the drawing) of an optical waveguide 51 is formed to be complementarily opened with respect to the light-extracting element 54 when viewed from the side of the display screen in the vicinity of the boundary portion between the light-emitting areas A and B. As stated above, a mosaic structure in which the light-extracting elements 54 and 55 are mixed with each other when viewed in the direction vertical to the display screen, is formed in the vicinity of the boundary portion between the light-emitting areas A and B. Thus, even if there is a minute brightness difference between the light-emitting areas A and B, a joint becomes unnoticeable on the display screen.

As described above, according to this embodiment, it is possible to realize the scan type illumination device which can reduce the uneven brightness between the light-emitting areas and the display apparatus including the same. Accordingly, the display characteristics in which the brightness of the display screen is uniform and excellent can be obtained, and it is possible to realize the liquid crystal display apparatus which enables the support of moving images whose importance becomes high in future.

[Third Embodiment]

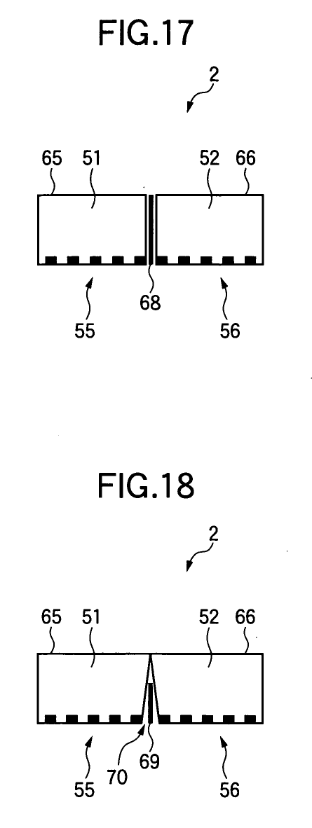

Next, an illumination device according to a third embodiment of the invention and a display apparatus including the same will be described with reference to FIGS. 17 to 23 while referring to FIG. 6. In the liquid crystal display apparatus shown in FIG. 6, in order to support the moving image display, the backlight unit 2 is used which realizes black writing in each frame by partial flashing of the light source. The backlight unit 2 has the two-layer structure of the upper optical waveguides 51 and 52 and the lower optical waveguides 50 and 53. When viewed from the side of the display screen, the lower optical waveguides 50 and 53 are substantially equal to the upper optical waveguides 51 and 52 in width (in the direction perpendicular to the paper surface of the drawing) and are about half in length (in the horizontal direction in the drawing). Accordingly, when viewed from the side of the display screen, the superficial content of the lower optical waveguide 50, 53 is about half of the superficial content of the upper optical waveguide 51, 52. The light-extracting element 55 is formed on the back side (lower side in the drawing) of the upper optical waveguide 51 only in the area where it does not overlap with the lower optical waveguide 50. On the back side of the lower optical waveguide 50, the light-extracting element 54 is formed in the area where it overlaps with the upper optical waveguide 51, that is, almost the whole area. Similarly, the light-extracting element 56 is formed on the back side of the upper optical waveguide 52 only in the area where it does not overlap with the lower optical waveguide 53. The light-extracting element 57 is formed on the back side of the lower optical waveguide 53 in the area where it overlaps with the upper optical waveguide 52, that is, almost the whole area.

FIG. 17 is an enlarged view of an area a of the backlight unit 2 shown in FIG. 6. As shown in FIG. 17, the upper optical waveguides 51 and 52 adjacent to each other are optically separated from each other. A reflecting mirror 68 (not shown in FIG. 6) is disposed at the boundary portion between the upper optical waveguides 51 and 52 and is sandwiched between both the optical waveguides 51 and 52.

The backlight unit 2 shown in FIGS. 6 and 17 has two problems in structure. The first problem is that since the intensity of light at the joint portion between the upper optical waveguides 51 and 52 is low, a streak-like dark portion is visually identified on the display screen. The second problem is that since the length of the upper optical waveguide 51, 52 is different from the length of the lower optical waveguide 50, 53, a brightness difference occurs between the light-emitting areas A and B and between the light-emitting areas C and D. In addition, since the upper optical waveguides 51 and 52 and the lower optical waveguides 50 and 53 are stacked with each other, the backlight unit 2 has structural defects such as an increase in weight, an increase in manufacture cost, and the like.

In this embodiment, the first problem is solved by reducing the height of the reflecting mirror 68 disposed at the joint portion. In the structure of the general backlight unit 2, the reflecting mirror 68 is provided so that light guided in the optical waveguide 51 (or 52) is not incident on the adjacent optical waveguide 52 (or 51), and both the optical waveguides 51 and 52 are optically completely separated from each other. This causes the streak-like dark portion to be visually identified at the joint portion. When the height of the reflecting mirror 68 is reduced and the optical separation of both the optical waveguides 51 and 52 is made incomplete, although slight light leak to the adjacent optical waveguides 51 and 52 occurs, the streak-like dark portion more noticeable than the light leak on the display screen is not visually identified.

Besides, in this embodiment, the second problem is solved by making the length of the upper optical waveguide 51, 52 almost equal to the length of the lower optical waveguide 50, 53. That is, the distance between the cold-cathode tube 47 of the upper optical waveguide 51 and the light-extracting element 55 is made almost equal to the distance between the cold-cathode tube 46 of the lower optical waveguide 50 and the light-extracting element 54. Besides, the distance between the cold-cathode tube 48 of the upper optical waveguide 52 and the light-extracting element 56 is made almost equal to the distance between the cold-cathode tube 49 of the lower optical waveguide 53 and the light-extracting element 57. By this, the brightnesses of the light-emitting areas A and B and the light-emitting areas C and D become respectively almost equal to each other. Further, the brightnesses of the light-emitting areas A to D become almost uniform by decreasing the brightness difference between the light-emitting area A, B and the light-emitting area C, D.

Further, in this embodiment, the structure of the backlight unit 2 is simplified by providing a liquid crystal shutter as an optical shutter on the liquid crystal display panel 3 side of the non-flashing type general backlight unit 2. As the liquid crystal shutter, it is desirable to use a double guest-host type in which a polarizing plate becomes unnecessary. The double guest-host type liquid crystal shutter has a structure in which two guest-host mode liquid crystal panels are stacked. The two liquid crystal panels are disposed so that the inclination direction of liquid crystal molecules of one of them is orthogonal to the inclination direction of liquid crystal molecules of the other. By this, it is possible to obtain the backlight unit 2 in which light absorption by the polarizing plate does not occur and the brightness is high. Besides, the light transmissivity at the time of non-driving is further improved by using a vertical alignment mode liquid crystal panel, and the backlight unit 2 having higher brightness can be obtained.

Hereinafter, an illumination device according to this embodiment and a display apparatus including the same will be described by use of specific examples.

### EXAMPLE 3-1

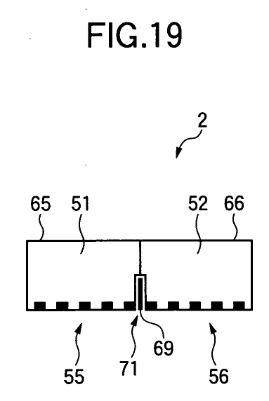

First, an illumination device according to example 3-1 of this embodiment will be described with reference to FIGS. 18 and 19. FIG. 18 is a partial sectional view showing a structure of the illumination device according to this example, and shows an area corresponding to FIG. 17. As shown in FIG. 18, a gap part 70 in which its back side is opened into a A shape is provided between an optical waveguide 51 and an optical waveguide 52 joined to each other. A reflecting mirror 69 is provided on a back side from a predetermined position of the gap part 70. The height of the reflecting mirror 69 is, for example, slightly lower than the thicknesses of the optical waveguides 51 and 52. Accordingly, the optical waveguides 51 and 52 are not optically completely separated from each other. Thus, light from the one optical waveguide 51 (or 52) partially leaks toward the adjacent other optical waveguide 52 (or 51) in the surface side of the gap part 70.

In this example, the height of the reflecting mirror 69 is made low, and the optical separation of both the optical waveguides 51 and 52 is made incomplete. By this, although the slight light leak occurs from the optical waveguide 51 (or 52) to the optical waveguide 52 (or 51), a streak-like dark portion more noticeable than the light leak is not visually identified on the display screen.

FIG. 19 is a partial sectional view showing a modified example of the illumination device according to this example. As shown in FIG. 19, a gap part 71 whose back side is opened to form a C shape is provided between an optical waveguide 51 and an optical waveguide 52 joined to each other. A reflecting mirror 69 is provided in the gap part 71. The height of the reflecting mirror 69 is, for example, slightly lower than the thicknesses of the optical waveguides 51 and 52. Accordingly, the optical waveguides 51 and 52 are not optically completely separated from each other, and light from the optical waveguide 51 (or 52) partially leaks toward the adjacent optical waveguide 52 (or 51) in the surface side of the gap part 70. Also according to this modified example, the same effect as the above example can be obtained. Incidentally, in the structure shown in FIGS. 18 and 19, although the independently formed optical waveguides 51 and 52 are joined to each other, the optical waveguides 51 and 52 may be integrally formed.

### EXAMPLE 3-2

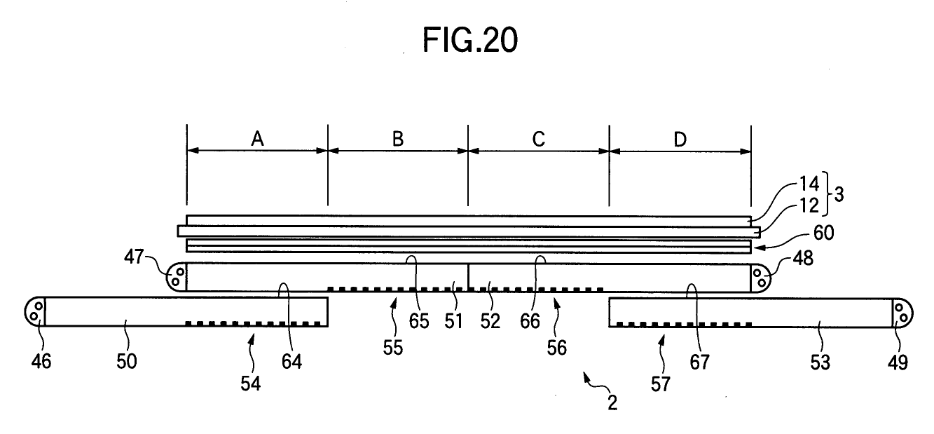

Next, an illumination device according to example 3-2 of this embodiment and a display apparatus including the same will be described with reference to FIG. 20. FIG. 20 shows a sectional structure of the illumination device according to this example and the display apparatus including the same. As shown in FIG. 20, two upper optical waveguides 51 and 52 are disposed on almost the same plane of the back side (lower side of the drawing) of a liquid crystal display panel 3. The optical waveguide 51 is disposed in light-emitting areas A and Band the optical waveguide 52 is disposed in light-emitting areas C and D. An optical waveguide 50 having almost the same shape and the same length as the optical waveguide 51 is disposed on the back side of the optical waveguide 51. The optical waveguide 50 is disposed in the light-emitting area A and its outside. An optical waveguide 53 having almost the same shape and the same length as the optical waveguide 52 is disposed on the back side of the optical waveguide 52. The optical waveguide 53 is disposed in the light-emitting area D and its outside.

A light-extracting element 54 is formed in the light-emitting area A of the back surface of the optical waveguide 50, and the light-extracting element 54 is not formed in the outside of the light-emitting area A. A light-extracting element 55 is formed in the light-emitting area B of the back surface of the optical waveguide 51, and the light-extracting element 55 is not formed in the light-emitting area A. Besides, a light-extracting element 56 is formed in the light-emitting area C of the back surface of the optical waveguide 52, and the light-extracting element 56 is not formed in the light-emitting area D. A light-extracting element 57 is formed in the light-emitting area D of the back surface of the optical waveguide 53, and the light-extracting element 57 is not formed in the outside of the light-emitting area D.

Since the optical waveguides 50 and 51 have the same shape and the same length, the distance between a cold-cathode tube 46 of the optical waveguide 50 and the light-extracting element 54 is almost equal to the distance between a cold-cathode tube 47 of the optical waveguide 51 and the light-extracting element 55. Besides, since the optical waveguides 52 and 53 have the same shape and the same length, the distance between a cold-cathode tube 48 of the optical waveguide 52 and the light-extracting element 56 is almost equal to the distance between a cold-cathode tube 49 of the optical waveguide 53 and the light-extracting element 57.

Accordingly, according to this example, the brightnesses of the light-emitting areas A and B and the light-emitting areas C and D can be made almost identical to each other. Further, the brightnesses of the light-emitting areas A to D can be made almost uniform by decreasing the brightness difference between the light-emitting area A, B and the light-emitting area C, D.

### EXAMPLE 3-3

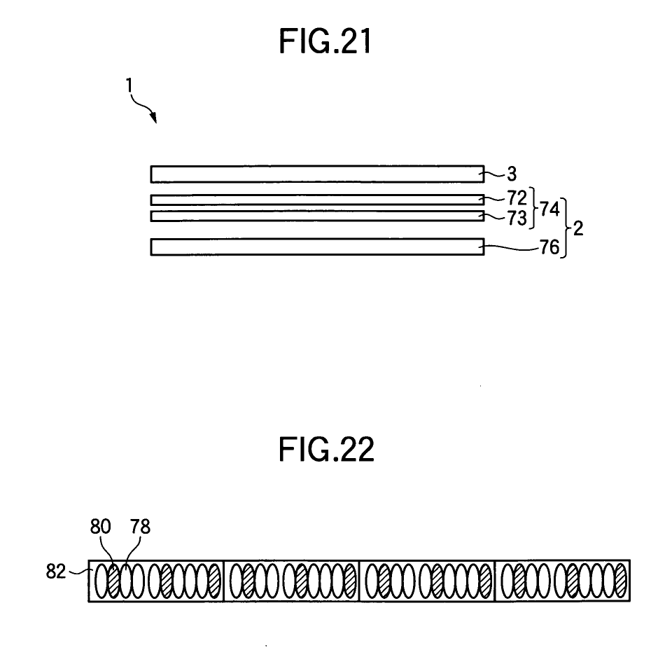

Next, an illumination device according to example 3-3 of this embodiment and a display apparatus including the same will be described with reference to FIGS. 21 to 23. FIG. 21 shows a schematic sectional structure of the illumination device according to this example and the display apparatus including the same. As shown in FIG. 21, a liquid crystal display apparatus 1 includes a liquid crystal display panel 3 and a backlight unit 2. A not-shown diffusion sheet and the like are disposed between the liquid crystal display panel 3 and the backlight unit 2.

The backlight unit 2 includes a sheet light source 76 and a liquid crystal shutter 74. The sheet light source 76 includes, for example, a general sheet optical waveguide and a non-flashing type cold-cathode tube disposed at an end of the sheet optical waveguide. The sheet light source 76 can illuminate the whole display area of the liquid crystal display panel 3.

The liquid crystal shutter 74 is of a double guest-host type in which guest-host mode liquid crystal panels 72 and 73 are stacked with each other. Each of the liquid crystal panels 72 and 73 is formed of two transparent substrates and a liquid crystal sealed between the two transparent substrates.

FIG. 22 is a sectional view schematically showing a liquid crystal layer of the liquid crystal panel 72. As shown in FIG. 22, since a dichroic pigment (guest liquid crystal) is added at a predetermined concentration to a liquid crystal (host liquid crystal) 82 of the liquid crystal panel 72, liquid crystal molecules 78 and dichroic pigment molecules 80 are mixed. A vertical alignment film is formed on a substrate surface in contact with the liquid crystal 82, and the liquid crystal molecules 78 and the dichroic pigment molecules 80 are disposed almost vertically to the substrate surface. The substrate surface is subjected to a predetermined alignment processing such as rubbing. Besides, the liquid crystal 82 has negative dielectric anisotropy. Accordingly, when a predetermined voltage is applied to the liquid crystal 82, the liquid crystal molecules 78 and the dichroic pigment molecules 80 are inclined in a predetermined direction. Although not shown, a liquid crystal layer of the liquid crystal panel 73 has almost the same structure as the liquid crystal layer of the liquid crystal panel 72.

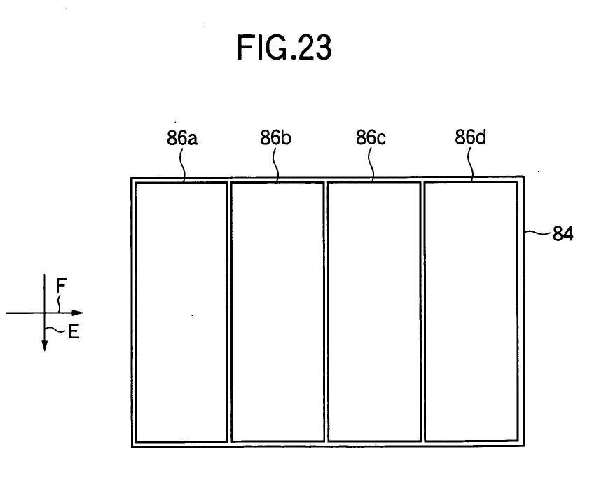

FIG. 23 shows a plane structure of one transparent substrate of the liquid crystal panel 72, 73. As shown in FIG. 23, for example, four-divided transparent electrodes 86a to 86d are formed on a transparent substrate 84. The transparent electrode 86a is formed in an area corresponding to the light-emitting area A, and the transparent electrode 86b is formed in an area corresponding to the light-emitting area B. The transparent electrode 86c is formed in an area corresponding to the light-emitting area C, and the transparent electrode 86d is formed in an area corresponding to the light-emitting area D. The respective transparent electrodes 86a to 86d are electrically separated from each other. Besides, although not shown, a transparent electrode is formed on the whole surface of the other transparent substrate of the liquid crystal panel 72, 73. By this, in the liquid crystal panel 72, 73, application/non-application of a voltage to the liquid crystal 82 can be selected for each of the light-emitting areas A to D. An arrow E in the drawing indicates the inclination direction of the liquid crystal molecules 78 of the liquid crystal panel 72, and an arrow F almost orthogonal to the arrow E indicates the inclination direction of the liquid crystal molecules 78 of the liquid crystal panel 73.

When a predetermined voltage is applied to the liquid crystal 82 of the light-emitting area A of the liquid crystal panel 72, the liquid crystal molecules 78 and the dichroic pigment molecules 80 are inclined in the direction of the arrow E. At this time, the liquid crystal panel 72 absorbs a polarized component parallel to the arrow E in the incident light. On the other hand, when a predetermined voltage is applied to the liquid crystal 82 of the light-emitting area A of the liquid crystal panel 73, the liquid crystal molecules 78 and the dichroic pigment molecules 80 are inclined in the direction of the arrow F. At this time, the liquid crystal panel 73 absorbs a polarized component parallel to the arrow F in the incident light. That is, when the voltage is applied to both the liquid crystal 82 of the light-emitting area A of the liquid crystal panel 72 and the liquid crystal 82 of the light-emitting area A of the liquid crystal panel 73, the light incident on the liquid crystal shutter 74 can be cut off.

As stated above, transmission/non-transmission of light can be switched for the respective light-emitting areas A to D by almost simultaneously switching application/non-application of voltage to the same light-emitting areas A to D of the liquid crystal panels 72 and 73 of the liquid crystal shutter 74, and by almost simultaneously driving the liquid crystal 82 of the same light-emitting areas A to D of the liquid crystal panels 72 and 73. Accordingly, the flashing type backlight unit 2 can be realized by using the non-flashing type sheet light source 76 and the liquid crystal shutter 74 disposed between the sheet light source 76 and the liquid crystal display panel 3.

[Fourth Embodiment]

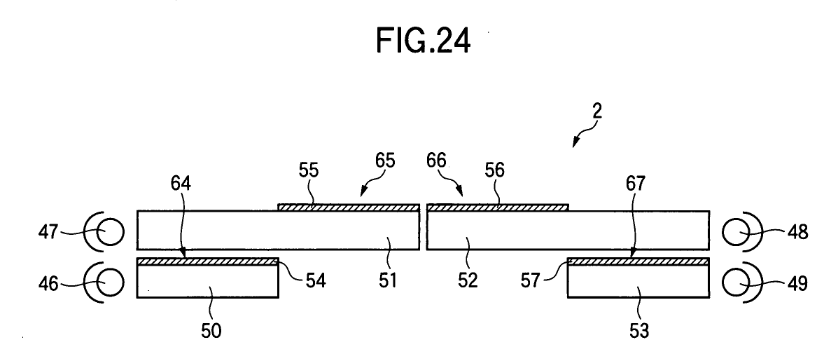

Next, an illumination device according to a fourth embodiment of the invention will be described with reference to FIGS. 24 to 28. In recent years, an active matrix type liquid crystal display apparatus including a TFT for each pixel has been widely used as a display apparatus for any use. In such circumstances, a liquid crystal display apparatus especially having high visibility in moving image display has been desired.

As an illumination device realizing a liquid crystal display apparatus having high visibility in moving image display, in Japanese Patent Application (Japanese Patent Application No. 2002-314955) by the same assignee, there is proposed a scan type illumination device having a structure as shown in FIG. 24. As shown in FIG. 24, in a backlight unit 2, cold-cathode tubes 46 and 47 (and cold-cathode tubes 48 and 49) are respectively provided for optical waveguides 50 and 51 (and optical waveguides 52 and 53) stacked in two stages. The scan type backlight unit 2 can be realized by sequentially turning on and off the cold-cathode tubes 46 to 49.

However, in the structure of the illumination device shown in FIG. 24, there is a feat that there arises a problem that a difference in light emission brightness between the cold-cathode tubes 46 and 47 (or the cold-cathode tubes 48 and 49) is apt to be visually identified as uneven brightness on a display screen. Besides, in the above structure, since the two optical waveguides 50 and 51 (and the optical waveguides 52 and 53) are disposed to vertically overlap with each other, there arises a problem that the total thickness becomes thick. An illumination device according to this embodiment which can solve these problems will be described by use of specific examples.

### EXAMPLE 4-1

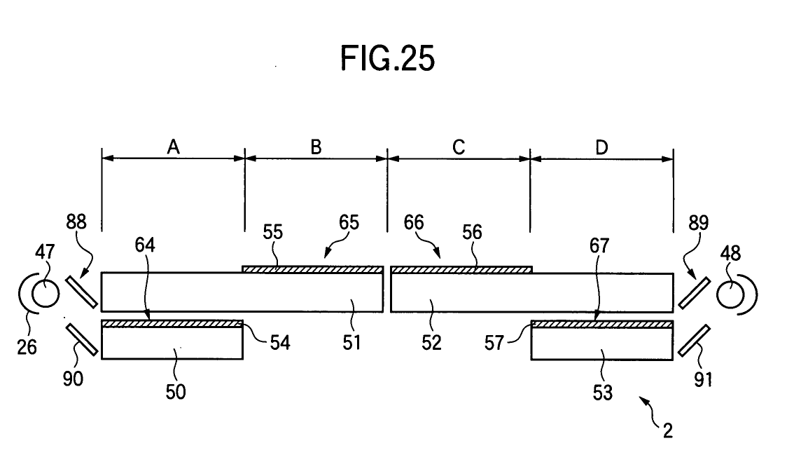

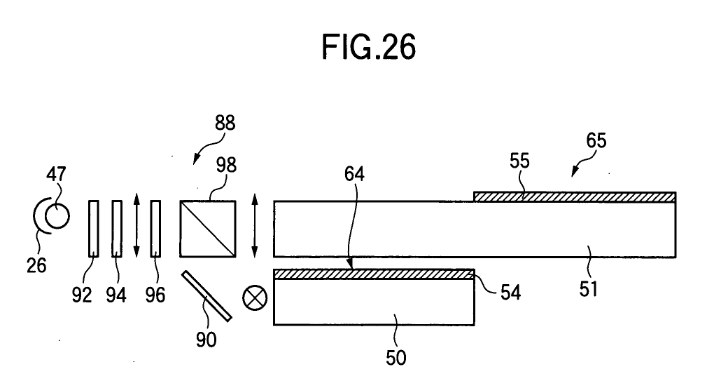

First, an illumination device according to example 4-1 of this embodiment will be described with reference to FIGS. 25 and 26. FIG. 25 is a sectional view showing a structure of the illumination device according to this example. As shown in FIG. 25, a light-extracting element 54 is formed in a light-emitting area A of a surface of an optical waveguide 50. A light-extracting element 55 is formed in a light-emitting area B of a surface of an optical waveguide 51, and the light-extracting element 55 is not formed in the light-emitting area A. A light-extracting element 56 is formed in a light-emitting area C of a surface of an optical waveguide 52, and the light-extracting element 56 is not formed in a light-emitting area D. A light-extracting element 57 is formed in the light-emitting area D of a surface of an optical waveguide 53.

A cold-cathode tube 47 is disposed in the vicinity of an end of the optical waveguide 51. An optical path changeover part 88 for changing an optical path is provided between the end of the optical waveguide 51 and the cold-cathode tube 47. A reflecting mirror 90 for causing light from the optical path changeover part 88 to be incident on the optical waveguide 50 is disposed in the vicinity of an end of the optical waveguide 50. Besides, a cold-cathode tube 48 is disposed in the vicinity of an end of the optical waveguide 52. An optical path changeover part 89 having the same structure as the optical path changeover part 88 is provided between the end of the optical waveguide 52 and the cold-cathode tube 48. A reflecting mirror 91 for causing light from the optical path changeover part 89 to be incident on the optical waveguide 53 is disposed in the vicinity of an end of the optical waveguide 53. The optical path changeover parts 88 and 89 can make a changeover so that incident lights from the cold-cathode tubes 47 and 48 travel in straight lines, or the traveling directions of the lights are bent by 90° toward the reflecting mirrors 90 and 91. Although the cold-cathode tubes 47 and 48 are respectively disposed in the vicinities of the optical waveguides 51 and 52, a cold-cathode tube is not disposed in the vicinities of the ends of the cold-cathode tubes 50 and 54.

FIG. 26 shows a structure of the vicinity of the optical path changeover part 88. As shown in FIG. 26, the optical path changeover part 88 is disposed in the vicinity of the cold-cathode tube 47, and includes a quarter-wave plate 92 for converting linearly polarized incident light into circularly polarized light. As the quarter-wave plate 92, for example, a polycarbonate film is used. A polarization selection layer 94 (for example, DBEF of 3M) which allows, for example, polarized light in the vertical direction of the drawing (direction parallel to the paper surface) to pass through and reflects polarized light in the direction vertical to the paper surface is disposed on the optical waveguide 51 side of the quarter-wave plate 92. A liquid crystal panel 96 which can make a changeover so that light from the polarization selection layer 94 passes through while the polarization direction is kept, or passes through while the polarization direction is rotated by 90° is disposed on the optical waveguide 51 side of the polarization selection layer 94. As the liquid crystal panel 96, for example, a TN mode or a VA mode is used. A polarizing plate having a polarization axis in the vertical direction of the drawing may be disposed between the liquid crystal panel 96 and the polarization selection layer 94. A polarization beam splitter 98 which allows, for example, polarized light in the vertical direction of the drawing to pass through and reflects polarized light in the direction vertical to the paper surface to bend the traveling direction of the polarized light toward the reflecting mirror 90 side by 90° is disposed on the optical waveguide 51 side of the liquid crystal panel 96. As the polarization beam splitter 98, for example, a combination of quartz glasses is used.

Next, the operation of the illumination device according to this example will be described. First, unpolarized light emitted from the cold-cathode tube 47 passes through the quarter-wave plate 92. The light having passed through the quarter-wave plate 92 is still unpolarized light although its polarization state is changed. Next, the light having the polarized component in the direction vertical to the paper surface is reflected by the polarization selection layer 94, and again passes through the quarter-wave plate 92 and becomes circularly polarized light. The light which has become the circularly polarized light is reflected by a reflector 26 of the cold-cathode tube 47, again passes through the quarter-wave plate 92, and becomes polarized light in the vertical direction of the drawing. As a result, only the light having the polarized component in the vertical direction of the drawing is emitted from the polarization selection layer 94, and reaches the liquid crystal panel 96. The liquid crystal panel 96 has, for example, a normally white mode, and a TN mode liquid crystal is sealed. The alignment direction of the liquid crystal of the liquid crystal panel 96 is set so that the direction at the polarization selection layer 94 side becomes the vertical direction of the drawing, and the direction at the polarization beam splitter 98 side becomes the direction vertical to the paper surface.

When a predetermined voltage is applied to the liquid crystal layer of the liquid crystal panel 96, the liquid crystal panel 96 allows incident light to pass through while its polarization direction is not changed. Thus, the incident light reaches the polarization beam splitter 98 while the polarization in the vertical direction of the drawing is kept. Since the polarization beam splitter 98 allows this light to pass through as it is, the light is incident on the optical waveguide 51. Accordingly, at this time, the light-emitting area B emits light.

On the other hand, when a voltage is not applied to the liquid crystal layer of the liquid crystal panel 96, the liquid crystal panel 96 rotates the polarization direction of the incident light by 90°. Thus, the incident light becomes the polarized light in the direction vertical to the paper surface and reaches the polarization beam splitter 98. The polarization beam splitter 98 reflects this light. The light reflected by the polarization beam splitter 98 is further reflected by the reflecting mirror 90 and is incident on the optical waveguide 50. Accordingly, at this time, the light-emitting area A emits light.

Incidentally, the light emitted from the light-emitting area A of the optical waveguide 50 and the light emitted from the light-emitting area B of the optical waveguide 51 are different from each other in the polarization direction. Thus, display characteristics can be further improved by bonding polarizing plates, which have polarization axes in different directions, to the respective corresponding areas to be illuminated of the liquid crystal display panel 3. Of course, a diffusion sheet 60 may be merely disposed between the backlight unit 2 and the liquid crystal display panel 3. Alternatively, it is effective that a half-wave plate is provided at the incident surface of the optical waveguide 50 or 51 to rotate the polarization orientation by 90°. By this, the polarization orientations in the insides of the optical waveguides 50 and 51 can be made uniform.

In this example, the light-emitting area A or B is made to emit light by changing the optical path of the light from the one cold-cathode tube 47, and the light-emitting area C or D is made to emit light by changing the optical path of the light from the one cold-cathode tube 48. Thus, uneven brightness on the display screen due to the difference in light emission brightness between the cold-cathode tubes 46 and 47 (or cold-cathode tubes 48 and 49) does not occur, and excellent display characteristics can be obtained.

Besides, in this example, the scan type backlight unit 2 can be realized by changing the application/non-application of voltage to the liquid crystal layer of the liquid crystal panel 96 at a predetermined frequency.

### EXAMPLE 4-2

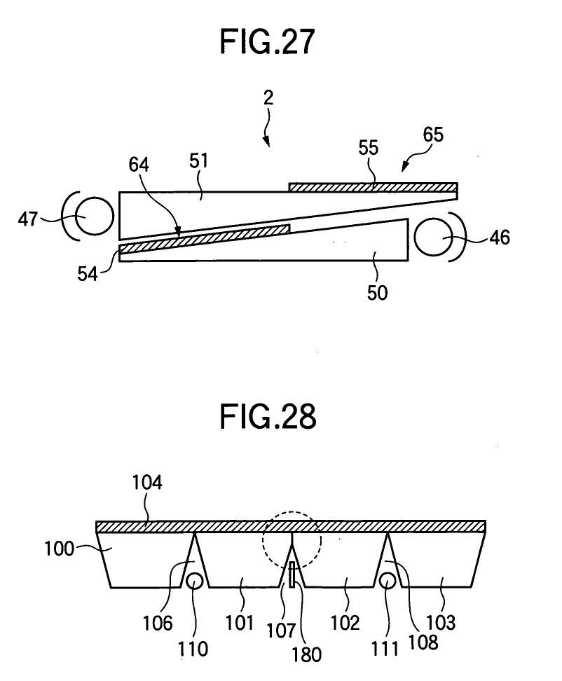

Next, an illumination device according to example 4-2 of this example will be described with reference to FIG. 27. FIG. 27 is a partial sectional view showing the structure of the vicinities of cold-cathode tubes 50 and 51 in the illumination device according to this example. As shown in FIG. 27, each of the optical waveguides 50 and 51 has a wedge shape. A cold-cathode tube 46 is disposed at one end of the optical waveguide 50. The optical waveguide 50 is such that its thickness on the side of the cold-cathode tube 46 is thick. A cold-cathode tube 47 is disposed at one end of the optical waveguide 51. The optical waveguide 51 is such that its thickness on the side of the cold-cathode tube 47 is thick. The optical waveguides 50 and 51 are disposed to form a nested shape mutually. Although not shown in FIG. 27, symmetrical structure optical waveguides 52 and 53 are disposed to be adjacent to the right sides of the optical waveguides 50 and 51 in the drawing. The optical waveguide 50 is shorter than the optical waveguide 51 and the cold-cathode tube 46 is disposed below a light-extracting element 55 of the optical waveguide 51. A uniform display without uneven brightness can be realized by suppressing a difference between the distance from the cold-cathode tube 47 to the light-extracting element 55 and the distance from the cold-cathode tube 46 to a light-extracting element 54 to about 20% or less. Here, with respect to the not-shown optical waveguides 52 and 53, it is needless to say that the optical waveguide 52 axisymmetric with the optical waveguide 51 can be united with the optical waveguide 51.

According to this example, as compared with the backlight unit 2 shown in FIG. 24, the backlight unit 2 whose total thickness is thin can be realized. The thickness of the backlight unit 2 is substantially equal to the backlight unit 2 using the parallel plate type optical waveguide. Besides, the thin backlight unit 2 supporting the scan type can be realized by sequentially turning on and off the cold-cathode tubes 46 to 49.

### EXAMPLE 4-3

Next, an illumination device according to example 4-3 of this embodiment will be described with reference to FIG. 28. In general, in a scan type backlight unit, since plural cold-cathode tubes provided for respective light-emitting areas are turned on and off, there arises a problem that a linear boundary portion between the adjacent light-emitting areas is apt to be visually identified. FIG. 28 is a sectional view showing a structure of the illumination device according to this example to solve the above problem. A backlight unit 2 according to this example has the structure used for both a direct type and a side light type, and corresponds to the scan type. As shown in FIG. 28, four optical waveguides 100 to 103 each having a substantially trapezoidal shape are disposed on almost the same plane so that surface sides (upper side in the drawing) are adjacent to each other. A wedge-shaped gap portion 106 is formed at the back side (lower side in the drawing) of the adjacent optical waveguides 100 and 101. Similarly, a wedge-shaped gap portion 107 is formed at the back side of the optical waveguides 101 and 102, and a wedge-shaped gap portion 108 is formed at the back side of the optical waveguides 102 and 103. A cold-cathode tube 110 is disposed in the gap portion 106 and a cold-cathode tube 111 is disposed in the gap portion 108. A light-extracting element 104 is provided at the surface side of the optical waveguides 100 to 103. The optical waveguides 100 and 101 and the cold-cathode tube 110 constitute a light source unit (100, 101, 110) for causing a predetermined light-emitting area to emit light. Besides, the optical waveguides 102 and 103 and the cold-cathode tube 111 constitute a light source unit (102, 103, 111) for causing another light-emitting area to emit light.

In an area surrounded by a broken line in the drawing between the optical waveguides 101 and 102, portions originally separated from each other are partially coupled. By this, a partial light is made to leak between both the optical waveguides 101 and 102 intentionally. However, basically, for the purpose of dividing the portion between the light-emitting areas, a reflecting mirror 180 is provided in the gap portion 107.

In this example, lights from both the optical waveguides 101 and 102 are mixed in the vicinity of the boundary portion between the optical waveguides 101 and 102, so that a linear boundary portion is not visually identified. Since the mixture of light in the boundary portion does not have a great influence on the moving image display, excellent display characteristics in the moving image display can be obtained according to this example.

As described above, according to this embodiment, it is possible to realize the scan type backlight unit 2 in which the brightnesses of the light-emitting areas are uniform and uneven brightness does not occur on the display screen. Besides, according to this embodiment, the thin scan type backlight unit 2 can be realized.

[Fifth Embodiment]

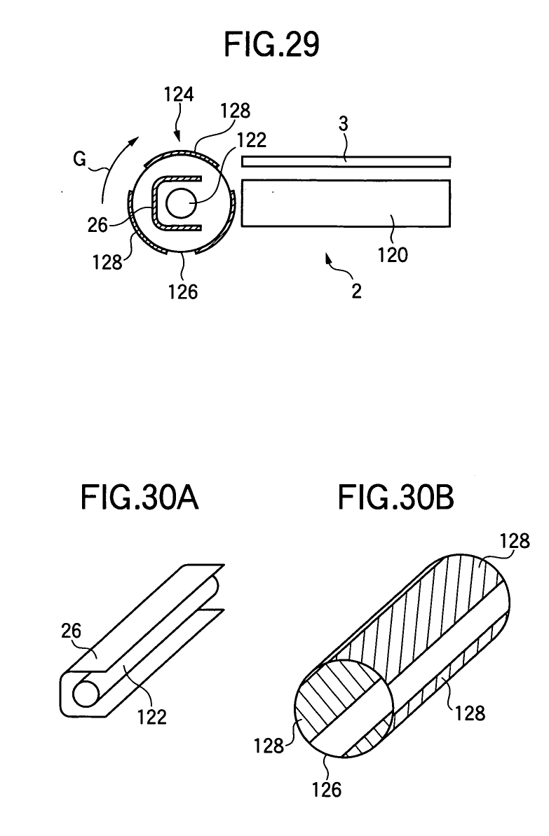

Next, an illumination device according to a fifth embodiment and a display apparatus including the same will be described with reference to FIGS. 29 to 32. A liquid crystal display apparatus is used for a display part of a notebook PC, a portable TV receiver, a monitor apparatus, a projection type projector and the like. However, a conventional color liquid crystal display apparatus has a problem that moving image characteristics are inferior to a CRT. In order to solve this problem and to obtain moving image display characteristics close to the impulse type CRT, an attempt has been made to perform a pseudo impulse display by a liquid crystal display apparatus whose display system is of a hold type. Although there are various methods, a light adjusting method of a backlight unit with little load on a liquid crystal display panel has been vigorously examined.

This embodiment is characterized in that light of a backlight unit is adjusted in order to obtain a liquid crystal display apparatus for realizing a pseudo impulse type display. As a first method, in a side-light type backlight unit, a cylindrical member having a reflecting film or a reflecting surface around a reflector of a cold-cathode tube is rotated, an incident angle of light incident on an optical waveguide is changed, and an area to be illuminated of a liquid crystal display panel is changed. Besides, as a second method, in a side-light type backlight unit, an optical waveguide in which a light-extracting element is not formed is used, several actuators optically coming in contact with/separating from the optical waveguide are disposed in parallel at the back side of the optical waveguide, and the respective actuators are sequentially driven so that any one of the actuators optically comes in contact with the optical waveguide. Hereinafter, an illumination device according to this embodiment and a display apparatus including the same will be described by use of specific examples.

### EXAMPLE 5-1

First, an illumination device according to example 5-1 of this embodiment and a display apparatus including the same will be described with reference to FIGS. 29 to 31. FIG. 29 is a sectional view showing the structure of the illumination device according to this example and the display apparatus including the same. As shown in FIG. 29, a substantially plate-shaped optical waveguide 120 is disposed at the back side of a liquid crystal display panel 3. Although not shown, a light-extracting element such as a scattering reflection pattern is formed in the whole area of the back side of the optical waveguide 120. A light source part 124 is disposed in the vicinity of one end of the optical waveguide 120. The light source part 124 is disposed at the upper side of the optical waveguide 120 when viewed from, for example, the display screen side. The light source part 124 includes a cold-cathode tube 122, a reflector 26 and a cylindrical member 126.

FIG. 30A is a perspective view showing the structure of the cold-cathode tube and the reflector of the light source part 124, and FIG. 30B is a perspective view showing the structure of the cylindrical member. As shown in FIGS. 29, 30A and 30B, the reflector 26 opened at the optical waveguide 120 side and having a U-shaped section is disposed around the cold-cathode tube 122. The cylindrical member 126 formed of a light transmission material such as, for example, acryl is rotatably disposed around the cold-cathode tube 122 and the reflector 26 while an extension direction of the cylindrical member 126 is made a rotation axis. Stripe-like reflecting films 128 are formed as light non-transmission parts on the surface of the cylindrical member 126 so that for example, three slit-like openings (light transmission parts) extending in parallel to the rotation axis direction are disposed. The reflecting films 128 are formed by evaporation of, for example, aluminum. Incidentally, the cylindrical member 126 may have such a structure that it is formed of light reflection material such as aluminum and has slit-like opening portions. The cylindrical member 126 is rotated at a predetermined rotation speed in the direction of an arrow G by a not-shown driving part, and functions as a light emission direction changing part which can change the emission direction of light from the cold-cathode tube 122 in the thickness direction of the optical waveguide 120. In the structure of this example, the cylindrical member 126 makes, for example, a one-third turn in a frame period of a liquid crystal display apparatus subjected to line-sequential driving. By this, as described below, an area to be illuminated of the liquid crystal display panel 3 is changed.

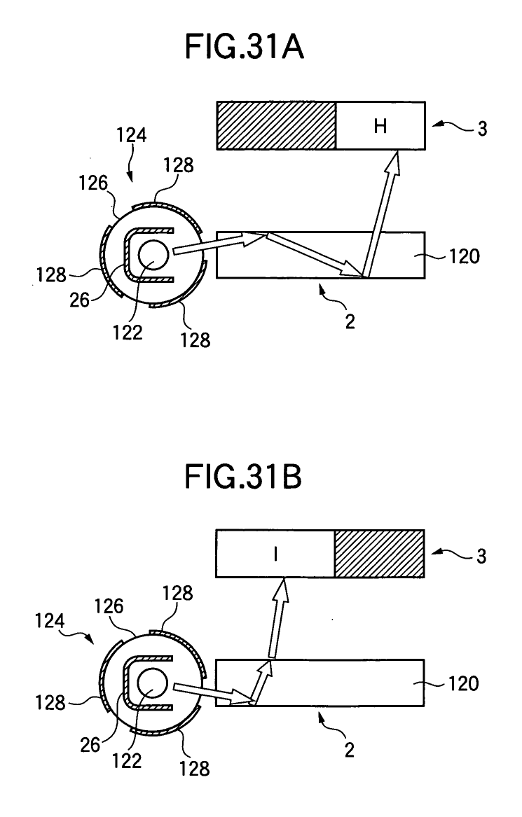

FIG. 31A shows a state of the light source part 124 at a certain time and an area of the liquid crystal display panel 3 which is illuminated. Besides, FIG. 31B shows a state of the light source part 124 at another time and an area of the liquid crystal display panel 3 which is illuminated. As shown in FIG. 31A, in the state where the opening portion is positioned toward the surface side of the optical waveguide 120 by rotation of the cylindrical member 126, light from the cold-cathode tube 122 is incident toward the surface side of the optical waveguide 120. As indicated by arrows in the drawing, after most of the incident light is total reflected at the surface of the optical waveguide 120, it is scattered and reflected by the scattering reflection pattern of the back surface of the optical waveguide 120 at an inner side (right side in the drawing) of the optical waveguide 120. The scattered and reflected light is emitted from the surface of the optical waveguide 120, and illuminates an area H of the liquid crystal display panel 3 at the lower side of the display screen. In this state, the area H at the lower side of the display screen emits light at a relatively high brightness.

On the other hand, as shown in FIG. 31B, in the state where the opening portion is positioned toward the back side of the optical waveguide 120, light from the cold-cathode tube 122 is incident toward the back side of the optical waveguide 120. As indicated by arrows in the drawing, most of the incident light is scattered and reflected by the scattering reflection pattern at the back surface of the optical waveguide 120 at a front side (left side in the drawing) of the optical waveguide 120. The scattered and reflected light is emitted from the surface of the optical waveguide 120, and illuminates an area I of the liquid crystal display panel 3 at the upper side of the display screen. In this state, the area I at the upper side of the display screen emits light at a relatively high brightness. Incidentally, since light reflected by the reflection film 128 of the cylindrical member 126 is again reflected by the reflector 26 and is emitted through the opening portion, the use efficiency of light is also improved.

At the time when the response of liquid crystal in a certain area of the liquid crystal display panel 3 is saturated, when the area is made to emit light at a relatively high brightness, the moving display characteristics can be improved. For example, a shift in emission period is adjusted so that at a time later, by ½ to ¾ period, than a time when gradation data is written in a pixel on a gate bus line of a certain area, the pixel is intensely illuminated. In this example, although the light source part 124 is disposed at one end of the optical waveguide 120, the light source part 124 may be disposed at both ends of the optical waveguide 120.

According to this example, the scan type backlight unit can be realized without turning on and off the cold-cathode tube 122. Besides, according to this example, since the use efficiency of light is improved, the scan type backlight unit with high brightness can be realized.

### EXAMPLE 5-2

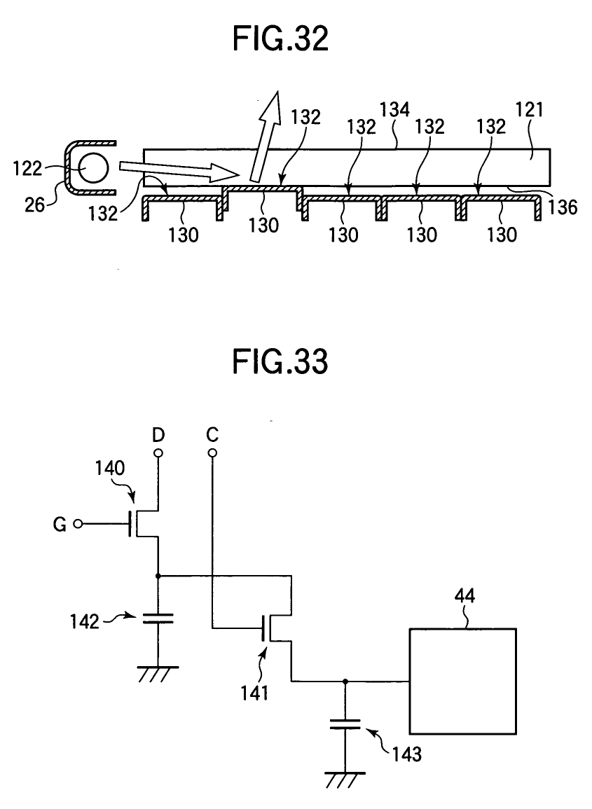

Next, an illumination device according to example 5-2 of this embodiment will be described with reference to FIG. 32. FIG. 32 is a sectional view showing a structure of the illumination device according to this example. As shown in FIG. 32, a backlight unit 2 includes a substantially plate-shaped optical waveguide 121 in which a diffusion reflection pattern is not formed. The optical waveguide 121 includes a light emission surface 134 for emitting light and an opposite surface 136 opposite to the light emission surface 134. A cold-cathode tube 122 is disposed in the vicinity of one end of the optical waveguide 121. A reflector 26 opened at the optical waveguide 121 side and having a U-shaped section is disposed around the cold-cathode tube 122. Several actuators 130 (five actuators are shown in FIG. 32) which can optically come in contact with/separate from the optical waveguide 121 by mechanical vertical motion are provided in parallel to each other at the back side of the optical waveguide 121. An optical reflecting plate 132 in which a light-extracting element such as a diffusion reflecting pattern is formed is attached, as a light reflecting surface, to a contact surface of each of the actuators 130 to the optical waveguide 121. The respective actuators 130 as the driving part perform driving so that any one of the optical reflection plates 132 sequentially comes in optical contact with the optical waveguide 121. As indicated by arrows in the drawing, light incident on the optical waveguide 121 is diffused and reflected only by the optical reflection plate 132 being in contact with the optical waveguide 121, and is emitted from the surface side of the optical waveguide 121.

At the time when the response of liquid crystal in a certain area of the liquid crystal display panel 3 is saturated, when the area is made to emit light, moving image display characteristics can be improved. For example, in an active matrix type liquid crystal display apparatus subjected to line-sequential driving, the optical reflection plate 132 in a corresponding area is brought into contact with the optical waveguide 121 in synchronization with any one of gate pulses so that at a time later, by ½ to ¾ period, than a time when gradation data is written in a pixel on a gate bus line of a certain area, the pixel is intensely illuminated. In this example, although the light source part 124 is disposed at one end of the optical waveguide 121, the light source part 124 may be disposed at both ends of the optical waveguide 121.

According to this example, the scan type backlight unit can be realized without turning on and off the cold-cathode tube 122. Besides, according to this example, since the use efficiency of light is improved, the scan type backlight unit with high brightness can be realized.

[Sixth Embodiment]

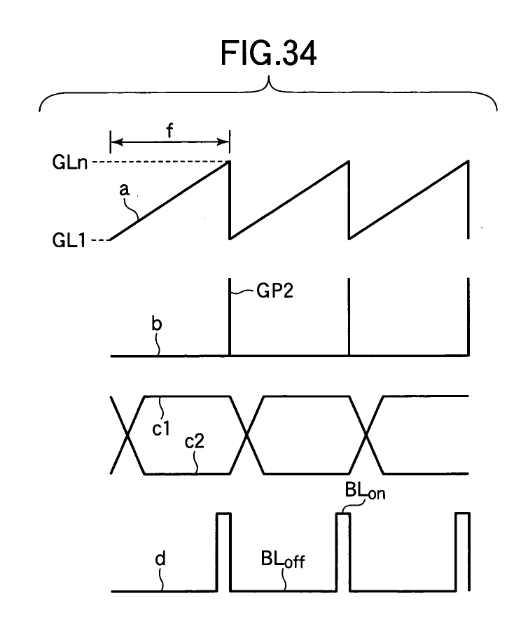

Next, an illumination device according to a sixth embodiment and a display apparatus including the same will be described with reference to FIGS. 33 and 34. In a general liquid crystal display apparatus, a desired display is obtained by writing gradation data into each pixel by line-sequential driving. However, since the liquid crystal display apparatus performs a hold type display in which the display of the gradation of each pixel written in a certain frame is kept in a frame period until a next frame, there is a problem that a display image blurs in a case where moving images are displayed. In order to solve this problem of the moving image blur, there is a scan backlight system liquid crystal display apparatus in which a backlight unit is divided for a plurality of respective areas, and a light source of each divided area is turned on and off in synchronization with writing of gradation data.

Incidentally, as a liquid crystal display apparatus performing a color display without using a color filter, there is a field sequential system in which one frame is divided into three fields of R, G and B. In the liquid crystal display apparatus of the field sequential system, there is known a structure (for example, see patent document 14) in which gradation data of all pixels are written at the same time so that a substantial writing period is shortened as compared with the line-sequential driving.

A display screen in which a moving image blur occurs causes an observer to sense vagueness, and causes uncomfortable feeling. However, in order to prevent the moving image blur, there arises a problem that the structure of the backlight unit must be made complicated. An object of this embodiment is to provide a display apparatus which can clearly display moving images by a simple structure and an illumination device used for the same.

FIG. 33 shows an equivalent circuit of each pixel of a liquid crystal display apparatus according to this embodiment. As shown in FIG. 33, a gate electrode of a first TFT 140 of each pixel is connected to a gate bus line (not shown). A drain electrode of the TFT 140 is connected to a drain bus line (not shown). A source electrode of the TFT 140 is connected to one electrode of a first storage capacitance (storage part) 142, and is connected to a drain electrode of a second TFT 141 (switching part). The other electrode of the storage capacitance 142 is kept at a common potential (for example, GND). The storage capacitance 142 of each pixel is designed so that when for example, the TFT 140 is turned on by a line-sequentially outputted first gate pulse, predetermined gradation data is written, and the gradation data is stored in a predetermined period.

A gate electrode of the TFT 141 is connected to a gate pulse output terminal of a not-shown driving part for outputting a second gate pulse. The second gate pulse in synchronization with input of a shift clock is outputted to the gate electrodes of the TFTs 141 of all pixels at the same time. A source electrode of the TFT 141 is connected to a pixel electrode 44, and is connected to one electrode of a second storage capacitance 143. The other electrode of the storage capacitance 143 is kept at the common potential. Gradation data written and stored in the first storage capacitance 142 of each pixel is written in the pixel electrode 44 and the storage capacitance 143 at the same time when the TFT 141 is tuned on. Since the TFTs 141 of all the pixels are tuned on at the same time, the gradation data is written in the pixel electrodes 44 and the storage capacitances 143 of all the pixels at the same time. It is desirable that the TFTs 140 and 141 are formed using poly-silicon enabling high integration.

FIG. 34 is a timing chart showing a driving method of the illumination device and the display apparatus including the same. In the drawing, the horizontal direction indicates time. A line a indicates a gate bus line (GL1 to GLn) corresponding to a pixel in which the gradation data is written in the storage capacitance 142. A line b indicates a gate voltage inputted to the gate electrode of the TFT 141 of each pixel. Lines c1 and c2 indicate pixel electrodes of each pixel. A line d indicates a light emission state of a backlight.

As indicated by the line a of FIG. 34, the gradation data are line-sequentially written from the storage capacitance 142 of the pixel on the gate bus line GL1 to the storage capacitance 142 of the pixel on the gate bus line GLn in a frame period f. As indicated by the line b, after the gradation data are written in the storage capacitances 142 of all the pixels, the second gate pulse GP2 is applied to the gate electrodes of the TFTs 141 of all the pixels at the same time. When the gate pulse GP2 is applied to the gate electrodes of the TFTs 141, as indicated by the lines c1 and c2, the gradation data are transferred from the storage capacitances 142 of all the pixels to the respective pixel electrodes 44 and are written. Incidentally, the liquid crystal display apparatus of this example is driven by, for example, frame inversion and line inversion. As indicated by the line d, the backlight is turned off (BLoff) in the period (almost one frame) when the gradation data are written in the respective pixels and the liquid crystal responds. The gate pulse GP of a next frame is applied and immediately before the pixel voltage of the respective pixels is changed, the backlight is turned on for a predetermined time (BLon).

In this embodiment, the backlight is turned on immediately before the gradation data are written into the pixels of the whole display area, and the whole display area is illuminated. Accordingly, as compared with the scan type backlight unit, moving images can be clearly displayed by the simple structure, and it is possible to realize the illumination device having excellent visibility and the display apparatus including the same.

Incidentally, in this embodiment, the gradation data are written in all the pixels of the display area at the same time, and the whole display area is illuminated by the backlight, however, the display area may be divided into plural areas and the respective divided areas may be illuminated at timings shifted by a predetermined period. In that case, a scan type backlight unit which can switch between lighting/lights-out (or high brightness/low brightness) for each of the plural light-emitting areas becomes necessary. A gate pulse GP2 is applied to the gate electrodes of the respective TFTs 141 of every divided area at the same time. The light-emitting area of the backlight unit corresponding to the divided area lights up for a predetermined time immediately before the gate pulse GP2 of a next frame is applied. Alternatively, the light-emitting area lights up at the highest brightness for a predetermined time immediately before the gate pulse GP2 of the next frame is applied.

In the conventional four-divided scan type backlight unit, a period from the end of scanning in each area to be illuminated to the emission of a corresponding light-emitting area is a ¾ period. On the other hand, in the structure in which the above example is applied to a four-divided scan type backlight unit, a period from the end of scanning in each area to be illuminated to the emission of a corresponding light-emitting area becomes almost one period. Thus, since the area can be illuminated after completion of response of the liquid crystal in each area to be illuminated, the moving image display characteristics are improved.

Besides, when gradation data are written in all pixels of a display area at the same time, since current flows to the whole display area at the same time, there is a fear that noise is apt to occur. In the above example, since the gradation data are written for each area to be illuminated, the occurrence of noise can be suppressed.

[Seventh Embodiment]

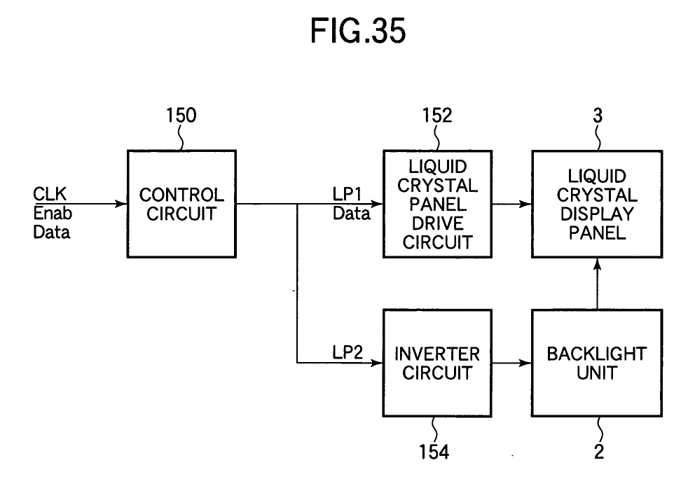

Next, an illumination device according to a seventh embodiment and a display apparatus including the same will be described with reference to FIGS. 35 to 40. In a conventional liquid crystal display apparatus, when moving images such as TV pictures are displayed, they are visually identified as blurred images by an observer. This moving image blur occurs since the response speed of liquid crystal is slow. In recent years, a drive compensation (overdrive) function (for example, see patent document 15) for applying a voltage having an amplitude larger than a gradation voltage to a liquid crystal layer is widely used in order to improve the response speed of the liquid crystal.

However, as compared with the CRT, the moving image quality is still inferior. This is because the CRT causes pulse light emission, and a moving image blur and ghost do not occur in the moving image display. On the other hand, since the liquid crystal display apparatus causes hold light emission or is of a hold type, a moving image blur and ghost occur in the moving image display. Especially, the moving image blur is notably visually identified. This is because the liquid crystal display apparatus uses a liquid crystal as an optical shutter and always allows light of predetermined transmissivity to pass through, and the display screen continuously emits light. The moving image blur can be improved by combining the drive compensation and intermittent lighting illumination.

FIG. 35 is a functional block diagram showing a structure of a general liquid crystal display apparatus including an intermittent lighting type backlight unit. As shown in FIG. 35, the liquid crystal display apparatus includes a control circuit 150 to which a clock CLK, a data enable signal Enab, gradation data Data and the like outputted from a system side of a PC or the like are inputted. The control circuit 150 outputs a timing signal LP1, gradation data Data and the like to a liquid crystal display panel driving circuit 152 such as a gate driver or a data driver. The liquid crystal display panel driving circuit 152 synchronizes with the timing signal LP1 and supplies predetermined signals to respective bus lines of a liquid crystal display panel 3. Besides, the control circuit 150 outputs a timing signal LP2 having a period that is integer times as large as the timing signal LP1 to an inverter circuit 154 as a lighting source control system. The inverter circuit 154 synchronizes with the timing signal LP2 and intermittently turns on a backlight unit 2 for illuminating the liquid crystal display panel 3.

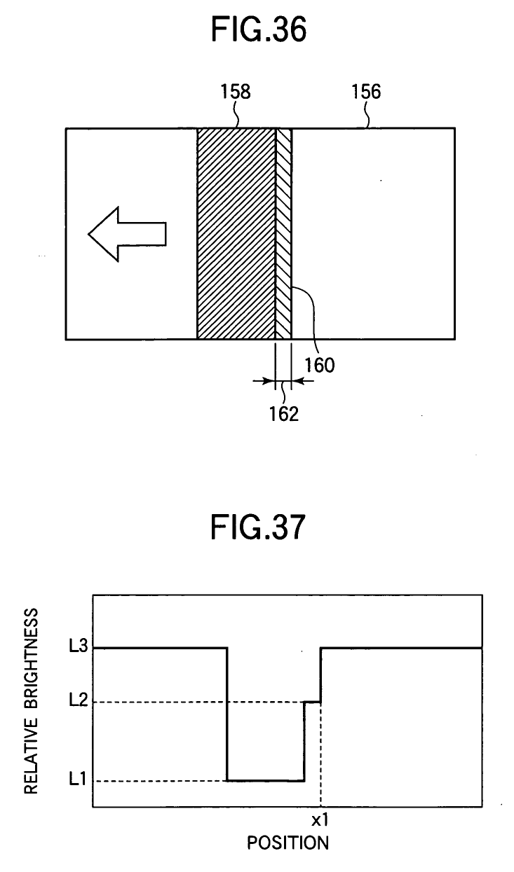

FIG. 36 shows a display screen of the liquid crystal display apparatus. FIG. 36 shows a band-shaped black image (black vertical band) 158 extending from the upper end to the lower end of a display screen 156 of the white background and moving in the left direction (direction of an arrow in the drawing). As shown in FIG. 36, a gray moving image blur (trailing) part 162 having a width of several pixels is generated on the right side of the black vertical band 158 moving in the left direction. A ghost 160 having the same shape as the right end side of the black vertical band 158 is visually identified at the right end side of the moving image blur part 162. Although the moving image blur is relieved by using the drive compensation function and the intermittent lighting illumination, the ghost 160 comes to be notably visually identified.

FIG. 37 shows a brightness profile of the display screen 156 which quantitatively indicates the moving image blur portion 162 and the ghost 160. The horizontal axis indicates position in the horizontal direction on the display screen 156, and the vertical axis indicates relative brightness. The relative brightness indicates an average value in the range from the upper end to the lower end of the display screen 156. As shown in FIG. 37, when the relative brightness of an area in which the white background is displayed is made L3, and the relative brightness of an area in which the black vertical band 158 is displayed is made L1, the relative brightness of an area in which the moving image blur portion 162 is displayed is L2 (L1<L2<L3). A brightness edge where the relative brightness is abruptly changed from L2 to L3 occurs at a position x1 of the right end of the area in which the moving image blur portion 162 is displayed. Thus, the boundary portion to the white background is stressed at the right end side of the moving image blur portion 162, and the ghost 160 is visually identified.

As stated above, the ghost 160 is visually identified as the same shape as the display image at the position spaced apart from the moving display image by several pixels. That is, when the black vertical band 158 is moved in the horizontal direction on the display screen 156 of the white background, a gray vertical streak in several pixels after the black vertical band 158 in the moving direction is seen by an observer as if it follows the black band.

The ghost 160 occurs since the response of liquid crystal is not ended in the lights-out period of the intermittently lighting backlight. In order to prevent the ghost 160 from being visually identified, it is necessary to cause the liquid crystal to respond at a high speed so that the response is completed in the lights-out period, however, this has not been realized. This embodiment has an object to provide a display apparatus in which the occurrence of a ghost 160 is suppressed, and a high quality moving image display is realized.

First, the principle of the display apparatus according to this embodiment will be described. As described before, since the ghost 160 has the same shape as the moving display image, its visual recognition is easy. When the shape of the ghost 160 is changed to prevent the shape recognition, visual identification becomes impossible. Accordingly, when the flashing period of the intermittently lighting backlight is controlled to prevent synchronization with the driving period of the liquid crystal, the visual identification of the ghost 160 can be made difficult. In order to make the flashing period of the backlight asynchronous with the driving period of the liquid crystal, at least one of conditions (1) the driving frequency of the illumination device is not integer times as large as the driving frequency (for example, 60 Hz) of the liquid crystal and (2) the driving phase of the liquid crystal is different from the driving phase of the illumination device has only to be satisfied.

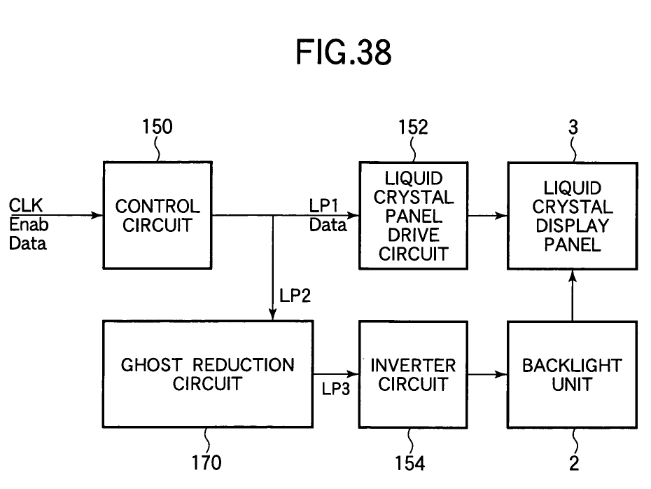

FIG. 38 is a functional block diagram showing a structure of the display apparatus according to this embodiment. As shown in FIG. 38, the display apparatus according to this embodiment includes, in addition to the same structure as FIG. 35, a ghost reduction circuit 170 as a light source control system added between a control circuit 150 and an inverter circuit 154. The ghost reduction circuit 170 receives a timing signal LP2, and outputs a timing signal LP3, which is converted so that at least one of a frequency and a phase varies, to the inverter circuit 154. The ghost reduction circuit 170 has functions of, for example, random conversion of frequencies, random conversion of phases, random conversion of both the frequencies and phases, and the like. By this, the flashing period of the backlight becomes asynchronous with the driving frequency of the liquid crystal display panel 3. For example, in the random conversion of phases, the phase of the writing signal to the liquid crystal display panel 3 is shifted from that of the flashing signal to the backlight unit 2. It is ideal that the phase is shifted for every frame (every writing).

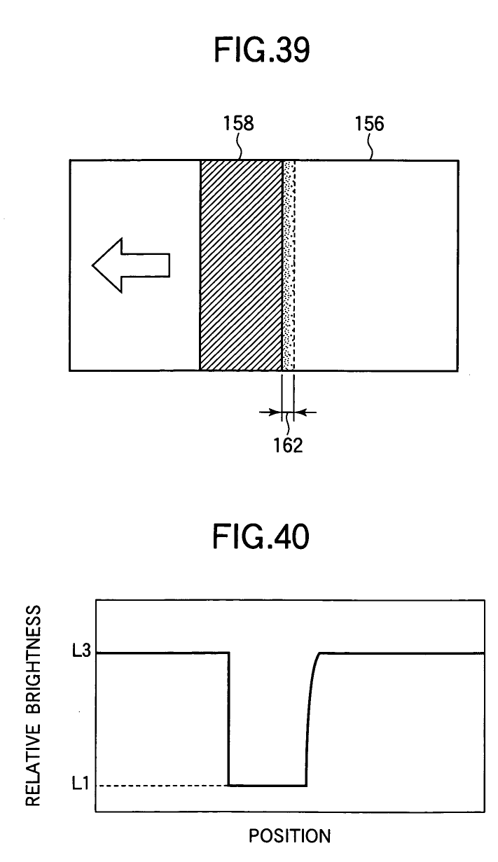

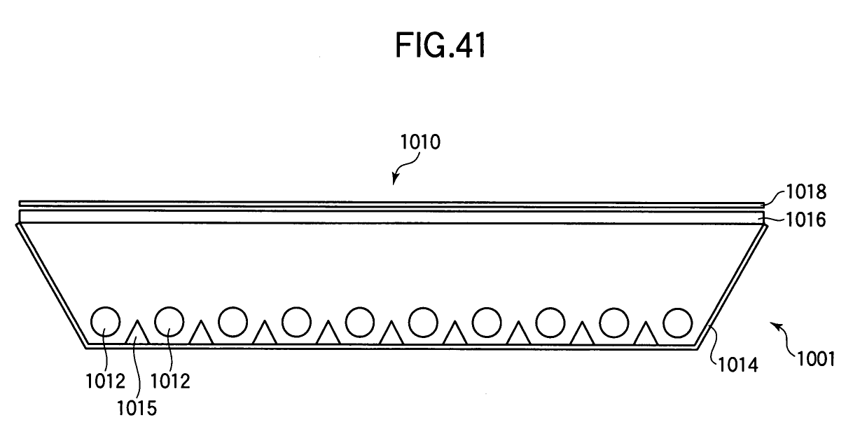

FIG. 39 shows a display screen of the liquid crystal display apparatus according to this embodiment, in which the same moving images as FIG. 36 are displayed. As shown in FIG. 39, in this embodiment, since the shape of the right end side of the moving image blur portion 162 is different from the shape of the black vertical band 158, the ghost 160 is not easily visually identified. Since the length of the moving image blur portion 162 in the horizontal direction in the drawing varies for every corresponding gate bus line, the boundary portion to the white background is not clearly visually identified.

FIG. 40 shows a brightness profile of the display screen 156 of the liquid crystal display apparatus according to this embodiment and corresponds to FIG. 37. When the brightness profile shown in FIG. 40 is compared with the brightness profile shown in FIG. 37, the relative brightness of the area in which the moving image blur portion 162 is displayed is changed relatively gently from L1 to L3, and the brightness edge does not occur. Thus, the boundary portion between the moving image blur portion 162 and the white background is unclear. That is, this means that the ghost 160 is blurred and is not easily visually identified.

According to this embodiment, since the ghost 160 does not occur, a high quality moving image display can be realized. Besides, when this embodiment is applied to the liquid crystal display apparatus having the drive compensation function, a remarkable effect is obtained.

As described above, according to the present invention, it is possible to realize the display apparatus in which excellent display characteristics can be obtained and the illumination device used for the same.

What is claimed is:

1. An illumination device comprising:
a plurality of optical waveguides each including a light diffusion reflecting surface for diffusing and reflecting guided light, a light emission surface for emitting the diffused and reflected light, and a plurality of light-emitting areas in which the light diffusion reflecting surface is formed and which are separated from each other, the plurality of optical waveguides being stacked so that the plurality of light-emitting areas are disposed almost complementarily when viewed in a direction vertical to the light emission surface; and
a plurality of light sources respectively disposed at ends of the plurality of optical waveguides.

2. An illumination device according to claim 1, wherein the light diffusion reflection surfaces are disposed not to overlap with each other between the plurality of optical waveguides when viewed in the direction vertical to the light emission surface.

3. An illumination device according to claim 1, wherein the light diffusion reflection surfaces are disposed to partially overlap with each other between the plurality of optical waveguides when viewed in the direction vertical to the light emission surface.

4. An illumination device according to claim 1, further comprising a light source control system for sequentially intermittently turning on the plurality of light sources.

5. An illumination device comprising:
a first light source unit including a first optical waveguide and a first light source disposed at its end, and for mainly causing a first light-emitting area to emit light to illuminate a display panel; and
a second light source unit including a second optical waveguide stacked at the display panel side of the first light source unit and having a shape different from the first optical waveguide and a second light source disposed at its end, and for mainly causing a second light-emitting area adjacent to the first light-emitting area to emit light to illuminate the display panel.

6. An illumination device according to claim 5, wherein the first optical waveguide is thinner than the second optical waveguide.

7. An illumination device according to claim 5, wherein the first optical waveguide is ticker than the second optical waveguide.

8. An illumination device according to claim 5, wherein the first optical waveguide is wedge-shaped.

9. An illumination device according to claim 5, wherein the first and the second optical waveguides respectively include light-extracting elements complementarily mixed with each other, when viewed in a direction vertical to a surface of the display panel, in the vicinity of a boundary between the first and the second light-emitting areas.

10. An illumination device comprising:
a first light source unit including a first optical waveguide and a first light source disposed at its end, and for mainly causing a first light-emitting area to emit light to illuminate a display panel;
a second light source unit including a second optical waveguide disposed to be adjacent to the first optical waveguide on an almost same plane and a second light source disposed at its end, and for mainly causing a second light-emitting area adjacent to the first light-emitting area to emit light to illuminate the display panel; and
a reflecting mirror disposed between the first optical waveguide and the second optical waveguide and having a height lower than thicknesses of the first and the second optical waveguide.

11. An illumination device comprising:
a first light source unit including a first optical waveguide, a first light source disposed at an end of the first optical waveguide, and a first light-extracting element formed on the first optical waveguide and for extracting light from the first light source, and for mainly causing a first light-emitting area to emit light to illuminate a display panel; and
a second light source unit including a second optical waveguide stacked at the display panel side of the first light source unit and having an almost same length as the first optical waveguide, a second light source disposed at an end of the second optical waveguide, and a second light-extracting element formed in the second optical waveguide, disposed in a region where a distance from the second light source is equal to a distance between the first light source and the first light-extracting element and for extracting light from the second light source, and for mainly causing a second light-emitting area adjacent to the first light-emitting area to emit light to illuminate the display panel.

12. An illumination device comprising:
a planar light source for illuminating a display panel; and
an optical shutter disposed at the display panel side of the planar light source and enabling switching of transmission/non-transmission of light from the planar light source for a plurality of respective areas.

13. An illumination device according to claim 12, wherein the optical shutter includes two guest-host mode liquid crystal panels stacked so that inclination directions of liquid crystal molecules are orthogonal to each other.

14. An illumination device according to claim 13, wherein the liquid crystal panels have a vertical alignment mode.

15. An illumination device comprising:
a first optical waveguide;
a second optical waveguide stacked on the first optical waveguide;
a light source disposed at an end of the first or the second optical waveguide; and
an optical path changeover part for causing light from the light source to be incident on one of the first optical waveguide and the second optical waveguide.

16. An illumination device according to claim 15, wherein the optical path changeover part includes a polarization selection layer for allowing a linearly polarized light having a specified polarization direction to pass through, a liquid crystal panel enabling rotation of the polarization direction of the linearly polarized light, and a polarization beam splitter for causing the linearly polarized light whose polarization direction is rotated to be selectively reflected/transmitted.

17. An illumination device comprising:
a first light source unit including a first optical waveguide having a wedge shape and a first light source disposed at its end, and for mainly causing a first light-emitting area to emit light to illuminate a display panel; and
a second light source unit including a second optical waveguide having a wedge shape and stacked at the display panel side of the first optical waveguide to form a nested state, and a second light source disposed at its end, and for mainly causing a second light-emitting area adjacent to the first light-emitting area to emit light to illuminate the display panel.

18. An illumination device comprising:
a first light source unit including a plurality of first optical waveguides disposed on an almost same plane, and a first light source disposed between the plurality of first optical waveguides, and for mainly causing a first light-emitting area to emit light to illuminate a display panel; and
a second light source unit including a plurality of second optical waveguides disposed on an almost same plane with respect to the first optical waveguides and partially joined to the first optical waveguides, and a second light source disposed between the plurality of second optical waveguides, and for mainly causing a second light-emitting area to emit light to illuminate the display panel.

19. An illumination device comprising:
an optical waveguide for guiding light;
a light source disposed at an end of the optical waveguide; and
a light emission direction changing part for changing an emission direction of light from the light source at a predetermined period.

20. An illumination device according to claim 19, wherein the light emission direction changing part includes a cylindrical member which is rotatably provided to surround the light source and in which a light transmission part for allowing transmission of light and a light non-transmission part for preventing transmission of light are alternately disposed in a rotation direction.

21. An illumination device according to claim 20, wherein the cylindrical member is formed of a light transmission material, and the light non-transmission part is a reflection film formed of a light reflection material on a surface of the cylindrical member.

22. An illumination device according to claim 21, wherein the light reflection material is aluminum.

23. An illumination device according to claim 20, wherein the cylindrical member is formed of a light reflection material, and the light transmission part is an opening portion where the cylindrical member is opened.

24. An illumination device comprising:
an optical waveguide including a light emission surface for emitting light and an opposite surface opposite to the light emission surface;
a light source disposed at an end of the optical waveguide;
a plurality of light reflecting surfaces disposed to stand in a line at the opposite surface side of the optical waveguide and capable of optically coming in contact with/separating from the opposite surface; and
a driving part for causing the plurality of light reflecting surfaces to sequentially optically come in contact with the opposite surface.

25. An illumination device according to claim 24, wherein the optical waveguide diffuses and reflects light only at the light reflecting surface which is optically in contact.

26. An illumination device according to claim 24, wherein the driving part synchronizes with any one of gate pulses sequentially outputted to gate bus lines formed on the display panel to be illuminated by the light and causes the plurality of light reflecting surfaces to sequentially optically come in contact with the opposite surface.

27. A display apparatus comprising a display panel including a display area and an illumination device for illuminating the display area, wherein the illumination device is the illumination device according to claim 1.

28. A display apparatus comprising:
a display panel including a display area, for simultaneously writing specified gradation data at a specified timing to the whole display area or a pixel of each division area obtained by dividing the display area into plural parts; and
an illumination device for illuminating the pixel, in which the gradation data is written, immediately before the timing.

29. A display apparatus according to claim 28, wherein
the pixel includes a storage part for storing the gradation data, and a switching part for writing the gradation data into the pixel by input of a specified signal.

30. A display apparatus comprising:
a display panel including a display area;
an illumination device for illuminating the display area; and
a light source control system for causing the illumination device to emit light at a light emission timing varying for each period.

31. A display apparatus according to claim 30, wherein the light emission timing has a frequency that is not integer times as large as a driving frequency of the display panel.

32. A display apparatus according to claim 30, wherein the light emission timing has a phase different from a driving phase of the display panel.

33. A display apparatus according to claim 30, wherein the display panel has a drive compensation function.
